(19) United States
(12) Patent Application Publication
(10) Pub. No.: US 2009/0171910 A1
(43) Pub. Date: Jul. 2, 2009

(54) DATA EXCHANGE SYSTEM

(76) Inventor: Shahriar Sarkeshik, Northridge, CA (US)

Correspondence Address: THE ECLIPSE GROUP LLP, 10605 BALBOA BLVD., SUITE 300, GRANADA HILLS, CA, 91344, US

(21) Appl. No.: 12/096,978

(22) PCT Filed: Dec. 1, 2006
(86) PCT No.: PCT/US06/46014

§ 371 Date: Jun. 11, 2008

Related U.S. Application Data
(60) Provisional application No. 60/741,849, filed on Dec. 1, 2005.

(51) Int. Cl. G06F 17/30

(52) U.S. Cl. 707/3; 707/E17.108

(57) ABSTRACT

A system is provided that collects and stores data from different sources, such as individuals or companies, and associates all or part of the data collected from the input of a single source with an identifier. The system, upon receipt of an identifier provided by a requester, including, but not limited to, software, person, system, may then provide the data associated with the identifier to the requester in a specific format or a format that will allow the requester to process the associated data, which may include storing the associated data in a data management program and/or updating the associated data.

### RELATED APPLICATIONS

The application relates to PCT International Application No. PCT/US2006/______, titled “Commercial Transaction Facilitation System”, filed Dec. 1, 2006, which is incorporated into this application in its entirety, and which claims priority to both U.S. Provisional Application Ser. No. 60/790,316 filed on Apr. 7, 2006, titled “Data Exchange System” and U.S. Provisional Patent Application Ser. No. 60/741,849 filed on Dec. 1, 2005, titled “Information Sharing System.” This application is a continuation-in-part of PCT International Application No. PCT/US2005/025241 filed on Jul. 16, 2005 titled “Location Codes for Destination Routing”, which claims priority to U.S. Provisional Patent Application Ser. No. 60/588,585 filed on Jul. 17, 2004 titled “Method and System for Using Location Codes for Destination Routing”; U.S. Provisional Patent Application Ser. No. 60/622,511 filed on Oct. 26, 2004 titled “Location Codes for Destination Routing”; U.S. Provisional Patent Application Ser. No. 60/699,044 filed on Jul. 13, 2005 titled “Location Codes for Destination Routing”; and U.S. Provisional Patent Application Ser. No. 60/699,789 filed on Jul. 15, 2005 titled “Navigation System Interface System,” all to the above applications of which are incorporated in their entirety into this application. This application is also a continuation-in-part of PCT International Application No. PCT/US2005/025434 filed on Jul. 18, 2005 titled “Navigation Interface System”, which claims priority to U.S. Provisional Patent Application Ser. No. 60/588,585 filed on Jul. 17, 2004 titled “Method and System for Using Location Codes for Destination Routing”; U.S. Provisional Patent Application Ser. No. 60/622,511 filed on Oct. 26, 2004 titled “Location Codes for Destination Routing”; U.S. Provisional, Patent Application Ser. No. 60/699,044 filed on Jul. 13, 2005 titled “Location Codes for Destination Routing”; U.S. Provisional Patent Application Ser. No. 60/699,789 filed on Jul. 15, 2005 titled “Navigation System, Interface System”; and PCT International Application No. PCT/US2005/025241 filed on Jul. 16, 2005 titled “Location Codes for Destination Routing,” all to the above applications of which are incorporated in their entirety into this application. This application further claims priority to U.S. Provisional Application Ser. No. 60/790,316 filed on Apr. 7, 2006 and titled “Data Exchange System”, and U.S. Provisional Patent Application Ser. No. 60/741,849 filed on Dec. 1, 2005 and titled “Information Sharing System,” both applications of which are incorporated in their entirety in this application.

### FIELD OF THE INVENTION

The invention relates to a system to enable the exchange of data and, in particular, a system to enable information of a type that is typically distributed or exchanged to the public or to a specific group or a selected number of individuals and/or businesses.

### BACKGROUND

The amount of available information is increasing at a rate higher than any other period in history. Information is available from a variety of sources. During the last few decades, with the advent of computers, Internet and the worldwide web, a very efficient way of sharing data has been created. Now that there is an infrastructure for data sharing, attention has been shifted to finding, conveying, and extrapolating data. To that end, web browsers, websites and search engines, among other systems, have been created for these purposes.

Although information may be available electronically, users often find themselves re-inputting the same information into another program due to incompatibility. For example, if contact information is available on a web page, the user might need to re-input that information into contact management software due to differences in format. Further, information that is conveyed by other than electronic means may need to be converted by the user into an electronic format. An example is contact or event information conveyed verbally or via passing a business card, invitation or other non-electronic means of conveying information. Conveying of the information verbally is time consuming and if the information is to be inputted into a computer contact management system, inputting data is further time consuming and prone to mistake.

The problem with moving contact data from business cards, invitations, website, email or other data formats, is well known. To transfer information on business cards into electronic contact management systems, many companies now offer business card readers, which scan the information on the business cards and store the information in a contact-database. Additionally, some individuals transfer data to others in the form of “V-cards”. V-cards are electronic files created through Microsoft® Outlook®, registered trademarks of Microsoft Corporation. V-cards allow recipients to save the contact information of an individual contained in the V-card as an Outlook® contact. Further, card readers require manual double checking to make sure that the reader recorded the information on the card correctly. Additionally, V-cards require several email exchanges between the parties, where at least one party sends the other party a solicited or unsolicited V-card.

Business card readers and V-cards do not, however, offer any means for automatically updating old information. Accordingly, new programs have been introduced that request contact information from a person, in an electronic format, at the request of another person. These programs store the requested contact information in the requesters contact management system. While these new programs can provide for automatic updates of contact information, the sharing and dissemination of contact information requires the parties sharing the information to grant permissions to one another for the exchange or requires one party to invite the other to provide their information.

Therefore, a need exists to allow persons, such as individuals or companies, to convey, communicate, provide, retrieve and disseminate information in a manner that is useful to the user, simplifies viewing, recall or storing of the information and reduces error in recording the information.

It is recognized that persons, such as companies and individuals, may associate information, in the form of a webpage, with a specific URL that may be viewed using a web browser, which typically converts HTML data into a screen display, in the form of a webpage. Further, it is recognized that a specific URL can be stored in a person's favorites list, along with certain extracted HTML data, for the purposes of easily re-accessing a specific or frequently accessed website or webpage.

A need, however, exists for a system that provides access to, or retrieves, specific information using an information identifier for the purpose of viewing, storing and/or extrapolating the specific information, such as contact information or calendar information, in connection with a specific program designed to handle, process and/or store all or part of the specific information, such as a contact management system.

### SUMMARY

A system is provided that collects and stores data from different sources, such as individuals or companies, and associates all or part of the data collected from the input of a single source with an identifier. The system, upon receipt of an identifier provided by a requester, which may include, but not be limited to, software, a person or a system, may then provide the data associated with the identifier to the requester in a specific format or a format that will allow the requester to process the associated data. Processing the data may include storing the associated data in a data management program and/or updating the associated data.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a flow diagram that illustrates one example of one implementation of an information sharing system (“ISS”) interfacing with an information source and an information client.

FIG. 2 is a flow diagram that illustrates one example of one implementation of an ISS interfacing with an information source, an information client interface and a contact/scheduling management system.

FIG. 3 is a flow diagram that illustrates one example of one implementation of an ISS interfacing with an information source, an information client interface and a navigation system.

FIG. 4 is a flow diagram that illustrates one example of one implementation of an ISS interfacing with an information source interface, contact/scheduling management system and other databases, as well as an information client interface and a contact/management system.

FIG. 5 is a flow diagram that illustrates one example of one implementation of an ISS interfacing with an information source, information client and a contact/scheduling client.

FIG. 6 is a flow diagram that illustrates one example of one implementation of an ISS interfacing with an information source, information client, information source interface, other databases, information client interface, contact/management system and a contact/scheduling client.

FIG. 7 is an example of one business card with associated contact identifier.

FIG. 8 is one example of one implementation of how contact management software, such as Microsoft® Outlook®, may be enhanced by using identifiers to retrieve information from an ISS.

FIG. 9 illustrates one example of a user input on a cellular telephone.

FIG. 10a illustrates one example of a business card displaying a contact identifier.

FIG. 10b illustrates one example of an input screen that may be displayed on a cell phone for accepting an identifier.

FIG. 10c illustrates one example of a screen display presenting the corresponding associated data to the user for verification.

FIG. 10d illustrates one example of a screen display acknowledging that the data has been added to a cell phone user's contact database.

FIG. 10e illustrates one example of a screen display presenting directions to the address associated with the identifier.

FIG. 11a illustrates one example of a business card displaying an associated identifier and a security code.

FIG. 11b illustrates one example an input screen that may be displayed on a cell phone for accepting an identifier and security code.

FIG. 11c illustrates one example of a screen display that may be utilized to present the corresponding associated data to the user for verification.

FIG. 11d illustrates another example of one output screen that depicts the data provided by the server that corresponds to the identifier and security code.

FIG. 11e illustrates one screen display showing the automatic dialing of a telephone number associated with an identifier.

FIG. 12a illustrates one example of an input screen that may be displayed on a cell phone for receiving an identifier and a security code.

FIG. 12b illustrates one example of a screen display that may be utilized to present corresponding associated photos and/or videos.

FIG. 13a illustrates one example of an input screen that may be displayed on a cell phone for receiving an identifier and a security code for accessing on-line personal accounts.

FIG. 13b illustrates one example of a screen display that shows automatic access to a personal Yahoo!® account via the entry of an identifier with a particular security code.

FIG. 14a illustrates one example of how a website may include a request for entry of an identifier and security code.

FIG. 14b illustrates one example of an input screen that may be displayed on a cell phone for receiving an identifier and a security code for the purpose of viewing a number of associated on-line accounts.

FIG. 14c illustrates one example of a screen display showing various online accounts of an owner of an identifier and a list of websites that the owner may access.

FIG. 15a illustrates one example of how a group identifier for a particular company may be disseminated.

FIG. 15b illustrates one example of an input screen that may be displayed on a cell phone for receiving a group identifier.

FIG. 15c illustrates one example of a display that shows the name of the company associated with the group identifier, along with a list of nearest locations associated with the group identifier.

FIG. 15d illustrates one example of a user selecting one location associated with the group identifier.

FIG. 15e illustrates one example of a course plotted by a navigation program to the location selected in FIG. 15d from the current position of the cell phone user.

FIG. 16a illustrates one example of how an identifier for a specific event may be utilized by including the event identifier on an invitation.

FIG. 16b illustrates one example of a screen display that may be displayed on a cell phone for the entry of an identifier associated with an event.

FIG. 16c illustrates one example of particulars of an event associated with the entered identifier.

FIG. 16d illustrates one example of a display screen display showing a gift registry for the event of FIG. 16c.

FIG. 16e illustrates one example of a display screen showing the acquisition of weather data related to event data.

FIG. 17a illustrates one example of a screen display that may be displayed on a cell phone and that provides for the entry of an identifier associated with a group of individuals.

FIG. 17b illustrates one example of a screen display showing the data associated with the compound identifier illustrated in FIG. 17a.

FIG. 17c illustrates one example of a screen display showing the group schedule.

FIG. 17d illustrates one example of a screen display showing various options available to a user to process the displayed information in FIG. 17c.

FIG. 18a illustrates one example of a display screen of a navigation system that offers, as one alternative means, the entry of an identifier to obtain destination information.

FIG. 18b illustrates one example of a screen display on a navigation system for inputting an identifier.

FIG. 18c illustrates one example of how data associated with an identifier may be displayed to a user in connection with the operation of a navigation system.

FIG. 19 illustrates one example of how data associated with an identifier may be displayed to a user in connection with the operation of a navigation system.

FIG. 20 illustrates one example of how data associated with an identifier may be displayed to a user in connection with the operation of a navigation system.

FIG. 21 is one example of a screen display showing a travel itinerary having an input for an identifier.

FIG. 22a illustrates one example of an input screen that may be displayed on a cell phone to interface with an ISS.

FIG. 22b illustrates one example of a screen that may be displayed when the identifier and security code illustrated in FIG. 22a are entered.

FIG. 22c illustrates one example of a screen display that may be utilized to show a user profile.

FIG. 22d illustrates one example of a screen display that may be utilized to show shared photos associated with an identifier.

FIG. 22e illustrates one example of a screen display that may be utilized to show shared videos associated with an identifier.

FIG. 22f illustrates one example of a screen display that may be utilized to show shared music associated with an identifier.

FIG. 22g illustrates one example of a screen display that may be utilized to show information regarding friends of the owner of the data associated with the identifier.

FIG. 22h illustrates one example of a screen display illustrating different mechanisms by which an individual may be contacted.

FIG. 22i illustrates one example of a screen display showing an activities center that may provide access to a combination of personal information and allow a user to perform a variety of tasks.

FIG. 22j illustrates one example of a screen display that demonstrates the granting of user access to information associated with an identifier.

FIG. 22k illustrates one example of a screen display that allows an owner of data associated with an identifier to view a list of all the people and entities to which they have given data access.

FIG. 22l illustrates one example of a screen display that allows the owner of an identifier to view information about other registered users that meet specified criteria.

FIG. 23a illustrates an example of one input screen that may be displayed on a cell phone to interface with an ISS.

FIG. 23b illustrates an example of one screen display that may be retrieved when the identifier illustrated in FIG. 23a is entered into a cell phone.

### DETAILED DESCRIPTION

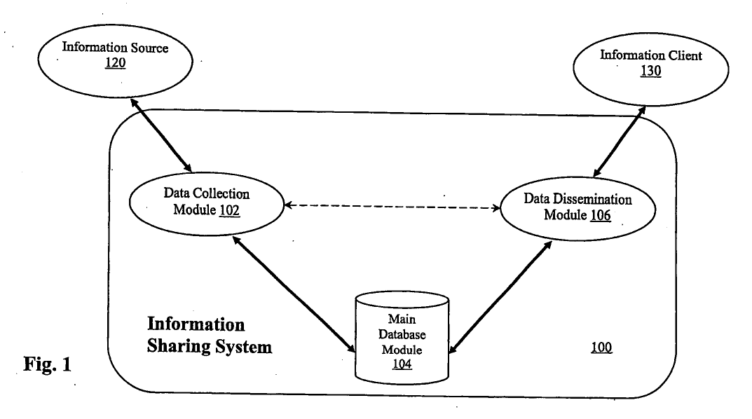

FIGS. 1-6 illustrate various block diagrams of examples of different implementations of an information sharing system (“ISS”) of the invention and its interaction with users, other systems and entities. In general, as illustrated in FIGS. 1-6, the ISS 100 includes a main database module 104 and a data collection module 102 for collecting data to be stored in the main database module 104. The data collection module 102, or other module in the ISS 100, can collect data from information sources 120, such as individuals and companies, and store the collected data in the main database module 104. The data collection module 102, or other module in the ISS 100, may assign or associates an identifier with all or part of the data collected from an information source 120. The ISS 100 further includes a data retrieval/dissemination module 106 for retrieving data from the main database module 104 associated with the identifier. The identifier can then be used by a requester to retrieve the data associated with the identifier utilizing the data retrieval/dissemination module 106. A requester can be a person, such as a company or an individual, or another software application, program or interface module capable of communicating with the ISS 100 for the purposes of retrieving the information associated with the identifier in a specified format to allow the requester or requesting system to do one or more of the foregoing, among other things: display data, extrapolate data, display extrapolated data, store extrapolated data, use data, manipulate data, format data, sort data, display the associated identifier and/or store the associated identifier.

Different functions of the ISS 100 are described in FIGS. 1-6 as flow diagrams of various modules and are provided as examples to convey functionality of the ISS 100. Those skilled in the art will recognize that the functionalities described in the examples can be implemented in a variety of ways upon examination of the description contained in this application. The described modules may be combined, divided, recombined, integrated, and/or removed fully or partially to create other implementation of the invention. It is intended that all such additional systems, methods, features, implementations and advantages be included within this description, be within the scope of the invention, and be protected by the accompanying claims.

FIG. 1 is a flow diagram of one example of one implementation of an ISS 100 including two modules: a data collection module 102 and a data dissemination module 106. The data collection module 102 is responsible for receiving information from an information source 120, coupling the information with an identifier and storing the information and the identifier in the main database module 104. The data collection module 102 may provide appropriate user interface when the information source 120 is interfaced by a person. The user interface may be presented to the user in form of a web page, or screen display on an electronic device, that allows the user to input the desired information. Alternatively, the information source 120 may have its own user interface that communicates with data collection module 102. The user interface may include separate fields for individual data types. The data collection module 102 may have a mechanism to allow recalling and modifying the data. The data collection module 102 may be connected to more than one information source 120 at a time. Similarly, an information source 120 may be connected to more than one data collection module 102 at a time.

Although all the examples only illustrate one main database module 104, the main database module 104 can be comprised of one or more separate databases. Further, more than one data collection module 102 can interface with a single database. Similarly, data collection module 102 and the information source 120 may be combined into one module included as part of the ISS 100.

The data gathered, handled or processed by the data collection module 102 may be of any type, including but not limited to, any type of entity information, contact information, event information, product information, multimedia data (including images, pictures, audio and/or video), financial information (including financial information for processing transactions), medical data, links, hyperlinks, metadata, databases etc. As used in this application, “metadata” is any data about data. For example, metadata may include, but not be limited to, information in the form of binary, text, characters, graphics, images, pictures, audio, video, animation, files, files created by different programs, organized or unorganized data, information, databases, links, hyperlinks, web pages, programs, attributes or any other format for communicating information. For purposes of this application, “data” shall mean information, segments of information or the raw material of information. Data may further include useful, irrelevant and/or redundant information or raw material. Data may take various forms, including, but not limited to, numbers, letters, symbols, text, graphics, images, audio and/or video and may comprise a single fact or a collection of facts, raw facts, statistical data, metadata, binary digits, measurements, concepts, instructions, animation, databases, links, programs, computer files, records, and etc.

The data collection module 102 couples one or more identifiers to the data received from the information source 120 and saves the identifiers, along with the received data, into the main database module 104. Identifiers may be assigned in a variety of ways. For example, an identifier may be assigned randomly by data collection module 102 chosen from available identifiers. For example, an identifier may be assigned using an algorithm. Alternatively, in another example of an implementation, the data collection module 102 may provide for a mechanism that allows the information source 120 to assign an identifier or choose one from a list provided. Part or all of the data provided by the information source 120 may be used to construct part or all of an identifier. For example, an email address or telephone number provided by an information source 120 may be used as an identifier. Another example is using the name provided by the information source 120 as part of an identifier. Since the same name may exist in the database, distinguishing character(s) may be added to the name to make it unique, e.g., JohnDoe123. Another example is using the telephone area code or the zip code provided as part of the identifier. Although not necessary, the number of characters in a given identifier may be fixed or fixed for a given type of entity or class. In one example of one implementation, the type of characters used in an identifier may be restricted to numbers or numbers and symbols. Further, one or more security codes may be used in connection with each identifier to control access to certain data. A set of identifiers may be set aside for a particular information source 120, for a particular type of information source 120 or a particular class of information sources 120. Examples of types of data identifiers and how they may be generated can be found in PCT International Patent Application No. PCT/US2005/025241 titled “Location Codes for Destination Routing”, which application is incorporated in its entirety into this application. Identifiers may be generated in the same manner as the generation of location codes as described in PCT/US2005/025241.

There are many different ways that data may be associated with an identifier. One example of such association techniques is using information or web technology. This includes, but is not limited to, using HTML, XHTML, XML, PDF, application programs, various multimedia formats, tables, lists, text files, binary files, structured files, databases, SQL, programming languages such as Flash, Java, Java script, C, C++, C#, among other programs, files, or languages, including proprietary association techniques etc. As web and information technology becomes more advanced with additional capabilities, these and other data association techniques may be used to enhance the user experience. A person familiar with the state-of-the-art may easily integrate such advancements for association of data with identifiers. Integration of such advancements and ability to use any known association technique is expected and is intended in the spirit of this invention.

In one example of one implementation, the data dissemination module 106 is responsible for receiving an identifier from an information client 130 or requester, looking-up the associated data from the main database module 104 and retrieving all or part or all of the associated data. The data dissemination module 106 may provide appropriate user interface when the information client 130 is interfaced by a person and may provide the retrieved data to the information client 130 via a user interface. This user interface may be presented to the user in form of a web page, or other screen display, that allows the user to input the desired identifier. Alternatively, in another example implementations the information client 130 may have its own user interface that communicates with data dissemination module 106. The data dissemination module 106 may also include a mechanism for processing the data before providing it. This processing may be based on the client's access right or based on the client's capabilities, preferences, requests or commands among other criteria Examples of processing include but not limited to filtering, sorting, constructing output in various formats (e.g. Text, HTML, XML, Java applet, Flash etc.). Processing may take into account the current date and/or time, location, preferences as well as other circumstances etc. Data dissemination module 106 may have the capability to be programmed or based on a request from the information client 130 to automatically disseminate data to desired clients upon occurrence of an event. The types of events include, but are not limited to, changes in the corresponding data in the database, time, request, location etc. The data provided by data dissemination module 106 may be delivered by variety of methods including, but not limited to, using the same communication channel used for receiving the identifier, text message, email, VCard, HTML, XML, database, multimedia formats etc. The delivery method may be preassigned or based on the client's capabilities, preferences or commands. The data dissemination module 106 may be connected to more than one information client 130 at a time. Similarly, an information client 130 may be connected to more than one data dissemination module 106 at a time.

Similar to the data collection module 102, more than one data dissemination module 106 can interface with a single database. Further, the main database module 104 may include more than one database. The data collection module 102 and data dissemination module 106 may communicate directly with one another to collect and provide information, as well as perform other task. This may occur, for example, when the data collection module 102 and the data dissemination module 106 communicate with more than one database. Further, although not shown, the data dissemination module 106 and the information client 130 may be combined into one module and included as part of the ISS 100.

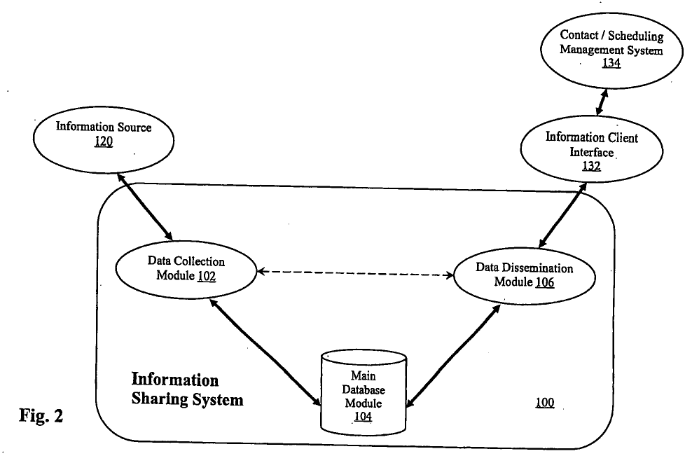

The data collection module 102 and information source 120 as well as the data dissemination module 106, information client 130 and other modules discussed in this document may be interfaced through any medium including, but not limited to, directly, a network, wired network, wireless network, Internet, LAN, WAN, or any other communications network. Further, the ISS 100, information source 120, as well as information client 130 and other modules discussed in this document may operate on any platform, including, but not limited to, servers, computers, PDAs, cell phones, GPS systems, navigation systems, other handheld and electronic storage devices, etc. FIG. 2 is another flow diagram that depicts another example of an implementation of ISS 100 where the data dissemination module 106 may be interfaced to a software program, which, in this example, is a contact/scheduling management system 134, via an optional information client interface 132. In this example, the information client interface 132 may be either a master, slave or peer to another program such as contact/scheduling management system 134. Some third party contact management programs such as Microsoft® Outlook® allow for seamless integration of a module similar to the information client interface 132. The information client interface 132 is capable of receiving data from the data dissemination module 106, translating it to a format required by another program such as contact/scheduling management system 134 and transferring the data. The information client interface 132 is also capable of initiating a request to the data dissemination module 106 utilizing an identifier. This request may include commands and/or parameters etc. The information client interface 132 may provide a user interface for inputting an identifier/security code, reviewing return data and sending it to a program such as contact/scheduling management system 134. The information client interface 132 may be initiated by a user, a program such as a contact/scheduling management system 134, data dissemination module 106 or an event, among others. The information client interface 132 may provide a mechanism for additional processing of the information received from the data dissemination module 106. This information processing may be controlled by commands, parameters, preferences, time, date, location, other circumstances among other things. Alternatively, in another example of an implementation, the information client interface 132 may be integrated completely into a program such as contact/scheduling management system 134, making the information client interface 132 an optional feature in the ISS 100. Similarly, the information client interface 132 may be integrated with the data dissemination module 106 of the ISS 100.

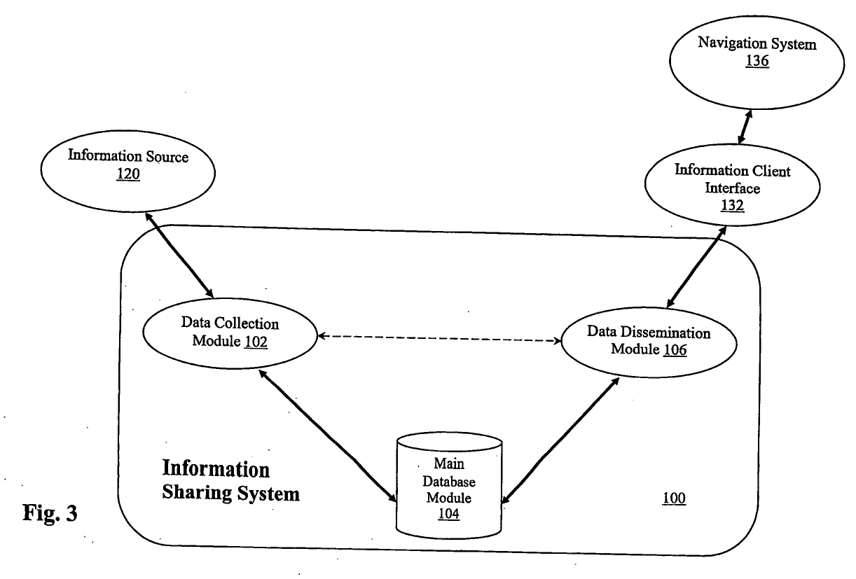

FIG. 3 is another flow diagram of another example of an implementation of an ISS 100 where the data dissemination module 106 is interfaced to a program, which, in this example, is a navigation system 136, via an optional information client interface 132. In this example, the information client interface 132 may be either a master, slave or peer to another program such as a navigation system 136. Some third party navigation programs 136, such as TomTom®, may allow for seamless integration of a module like the information client interface 132. Thus, the information client interface 132 may be integrated completely into a navigation system 136, making a separate information client interface 132 an optional feature in the ISS 100. The information client interface 132 may be capable of receiving data from the data dissemination module 106, translating it to a format required by another program, such as a navigation system 136 and transferring the data, such as address information, associated with an identifier. The information client interface 132 may also be capable of initiating a request to the data dissemination module 106 with an identifier. This request may include commands and/or parameters etc. The information client interface 132 may provide a user interface for inputting an identifier/security code, reviewing return data and sending it to a program such as navigation system 136. The information client interface 132 may be initiated by a user, a program such as navigation system 136, data dissemination module 106 or an event among other things. The information client interface 132 may provide a mechanism for additional processing of the information received from data dissemination module 106. This information processing may be controlled by commands, parameters, time, date, location, preferences, other circumstances among others. As set forth above, the information client interface 132 may be integrated completely into a program such as navigation system 136 and may therefore be an optional system module or may be integrated with the data dissemination module 106 of the ISS 100.

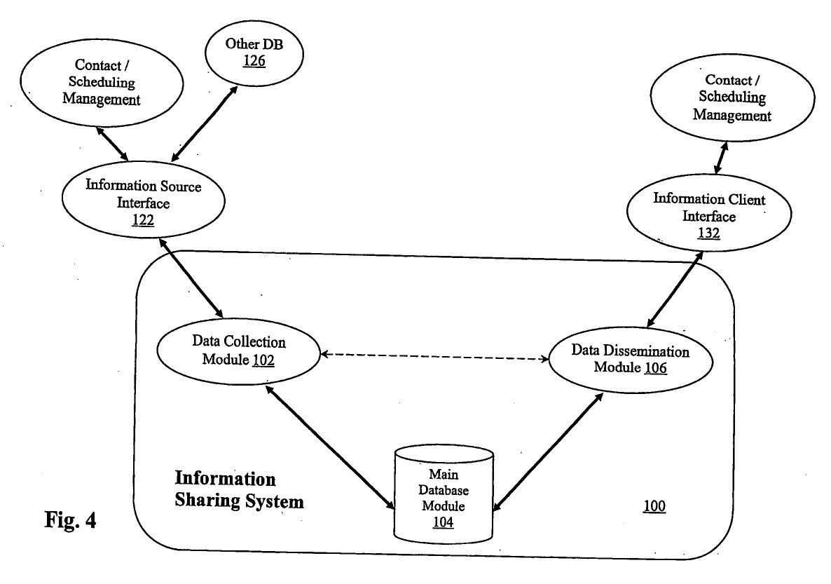

FIG. 4 is a flow diagram illustrating another example of an implementation of an ISS 100 where the data collection module 102 may be interfaced to a program, which, in this example, is a contact/scheduling management system 124 or other database 126, via an optional information source interface 122. In this example, an information source interface 122 may be either a master, slave or peer to another program such as a contact/scheduling management system 124 or may be another program capable of interfacing with a database of information 126. Some third party contact management programs such as Microsoft® Outlook® may allow for seamless integration of a module like: the information source interface 122. The information source interface 122 may be capable of receiving data from a program, translating it to a format required by the data collection module 106 and transferring the data. The information source interface 122 may also be capable of initiating a data transfer to the data collection module 106. This request may include commands, parameters, location, date, time, other circumstances etc. The information source interface 122 may provide a user interface for inputting the data, identifier, password, security code, reviewing data, modifying data and sending it to a data collection module 102. The information source interface 122 may be initiated by a user, a program such as contact/scheduling management system 124, data collection module 106 or an event among other things. The information source interface 122 may provide a mechanism for additional processing of the data before sending it to the data collection module 102. This information processing may be controlled by commands, parameters or preferences among others. The information source interface 122 may be integrated completely into a program such as contact/scheduling management system 124, making the information source interface 122 an optional feature. Further, the contact/scheduling management system 124 and the contact/scheduling management system 134 may be one and the same, interfacing both to the data collection module 102 and data dissemination module 106, or directly to the main database module 104. The information source interface 122 may be capable of interfacing with other databases 126 to retrieve relevant metadata, process/reformat data if necessary, and pass data to the data collection module 102 to be stored.

Those skilled in the art will recognize that more than one information source interface 122 and/or information client interface 132 may be interfaced with an ISS 100. Similarly, an information source interface 122 or information client interface 132 may interface to more than one ISS 100.

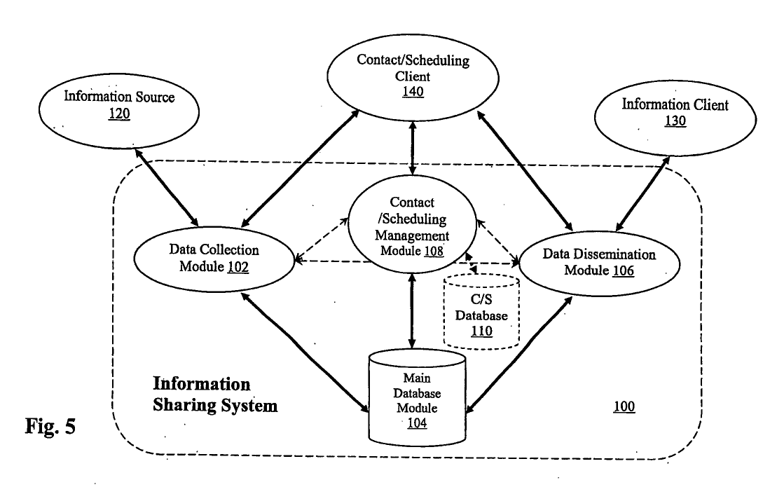

FIG. 5 is a flow diagram of another example of an implementation of an ISS 100 where a special purpose module, such as a contact/scheduling management module 108 has been added. This allows a contact/scheduling client 140 to be able to not only access part or all of the main database module 104 but also have an account within the ISS 100. The contact/scheduling management module 108 may provide the capability to create an account, add contact and/or schedules to the account directly or via using identifiers, look up information from the main database module 104 and save account information, among other activities. The contact/scheduling management module 108 may provide appropriate user interface(s) for a contact/scheduling client 140. The user interface(s) may be presented to the user in the form of a web page, or other screen display, that allows the user to input the desired information. Alternatively, the contact/scheduling client 140 may have its own user interface and that communicates with the contact/scheduling management module 108. The contact/scheduling client 140 may have the latest features expected from a contact management program. The contact/scheduling management module 108 may use the main database module 104 to store all or part of the individual client databases or use a separate database, such as a local client/scheduling database 110, which may be synced with other databases. In addition to communicating direction with the contact/scheduling management module 108, the contact/scheduling management client 140 may communicate directly with the data collection module 102 to provide data to the ISS 100 or may communicate directly with the data dissemination module 106 to gather data from the ISS 100.

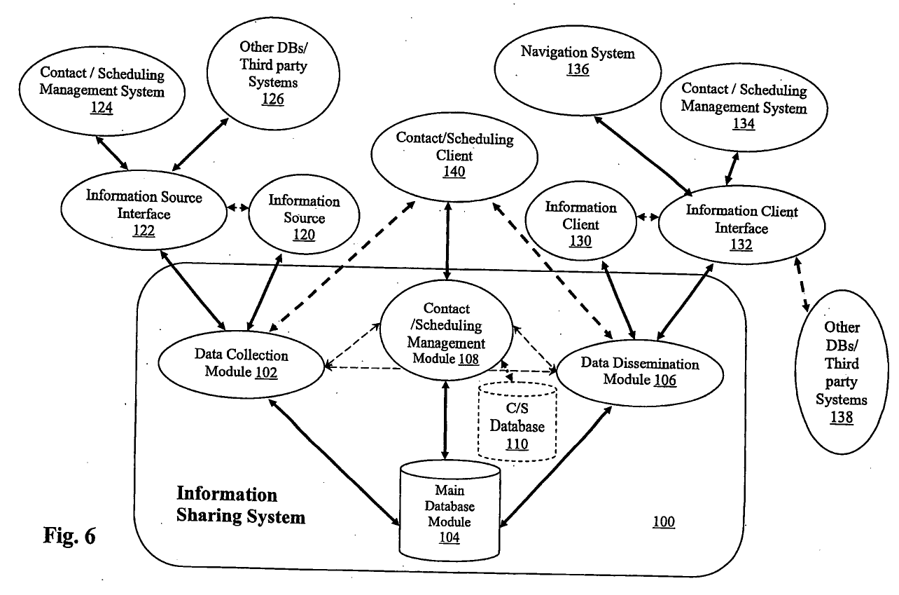

FIG. 6 is a flow diagram of one example of an implementation of an ISS 100 that includes all the functions and features of the example of implementations of the ISS 100 illustrated in FIGS. 1-5. As illustrated in FIG. 6, the information source 120 can interface with one or more persons or other entities as well as with the information source interface 122, which, optionally, may be incorporated as part of the information source 120. The information source interface 122 may interface with any other module(s), system(s) or program(s) such as a contact/scheduling management system 124 or other database(s) 126. The data collection module 102 can interface directly with a contact/scheduling client 140, information source interface 122 or an information source 120, among other modules. Further, a contact scheduling client 140, rather than interfacing with the data collection module 102, may interface with the main database module 104 via a contact/scheduling management module 108, and may store and retrieve data in either or both a contact/scheduling (“C/S”) database 110 or the main database module 104. The data dissemination module 106 may interface directly with a contact/scheduling client 140, an information client interface 132 or with an information client 130, among other modules. The information client 130 may interface with a person, people, entity or entities as well as with the information client interface 132, which, optionally, may be incorporated as part of the information client 130. The information client interface 132 may interface with any other module system or program such as a contact/scheduling management system 134, or may be integrated into such other module system or programs.

In operation, the ISS 100 may be implemented as a web-based application. Those skilled in the art will recognize that the ISS 100 may be a stand-alone application or may be implemented through a combination of software modules or programs, or a combination of hardware and software, any of which may run on one or more platforms, operating at one or more locations.

By way of example, if the ISS 100 was implemented as a web-application, the ISS 100 main database module 104 may be populated. The ISS 100 main database module 104 may be populated with preexisting data, may be populate by compiling data from information sources 120, or a combination of both. When populating the database with information from information sources 120, the data maybe acquired in a number of different manners. As an example, the ISS 100 may include a web-interface, which may serve as the information source interface 122, accessible by information sources 120, such as individuals or companies to input data. Such a web-interface may be accessible by the information sources 120 using web-browsers located on personal computers, personal digital assistants, telephones, including but not limited to cellular telephones, televisions, vehicle control units, including navigation systems, or any other similar devices or systems, including, but not limited to, handheld devices and electronic storage devices. Alternatively, as discussed above, the ISS 100, when operating as a stand-alone program or part of the software module, program or combination hardware/software system, all or part of the associated software may be installed locally on any of the above listed devices.

In this example, the web-interface may be part of the data collection module 102 or part of the information source interface 122, which may be integrated as part of the data collections module 102. The individuals or companies accessing the ISS 100 via the web interface to input data, may, as with most web-based applications, be required to create a user login and password. Once registered with the ISS 100, the individuals and companies may then be able to select different types of information that the individuals and companies desire to make available for dissemination to the public using the associated data identifier. For example, the users can enter contact data, such as contact data for individuals, companies, or groups of individuals or companies, and/or event data, such single event data, multiple event data, single or multiple event multi-session data and reoccurring event data or combination of the above. The ISS 100 may further provide the user with the ability to attach metadata to any of the foregoing data or to create data files that contain only metadata.

Once users are logged on to the ISS 100, the users may be provided with a menu that allows users to select the type of data that they desire to store into the system and associate with an identifier. The ISS 100 may allow the users to update information, as necessary, change identifiers, password protect identifiers, associate more than one data file or type of data, each having its own identifier, with a single identifier. The ISS 100 could store the data in the ISS 100 main database module 104 in accordance with known database storage methods, associating each data field with type identifiers to allow the data to be formatted and/or recognized by other applications when retrieved.

The ISS 100 may allow the user to select its identifiers, may randomly assign identifiers, may assign identifiers based upon user type or data type, may use all or part of the input data to generate all or part of the identifier, or may use any combination of the above or other method to generate an identifier. Any other known or new method for generating data identifiers may also be utilized. Once the data is stored, the user can logon to the ISS 100 and change and/or modify data files as necessary to keep information being disseminated current. One or more passwords with one or more level of access rights may be assigned to an identifier. Some of these passwords may be provided to third parties for purpose of adding, modifying and or accessing the associated data.

Additionally, individuals and companies 120 may provide data to the ISS 100 to populate the main database module 104 using information contained in contact/scheduling management systems 124 and/or other databases/third party systems 100. The information source 120 may request information from personal or company contact/schedule management systems 124 to be download or synchronized with the ISS 100 main database module 104. Such information may be synchronized using programs, such as Microsoft® Exchange Server. Additionally, information from other databases/third party systems 126 may be utilized to populate the main database module 104. Such database/third party systems 126 may include, but not be limited to, data that is stored on computers, servers, personal digital assistants, telephones, including but not limited to cellular telephones, televisions, vehicle control units, including navigation systems, or any other similar devices or systems, including, but not limited to, handheld devices and electronic storage devices, all of which may be accessible directly, or through networks, including but not limited to the Internet.

In addition to the information source 120 transferring data from contact/scheduling management systems 124 and other databases/third party systems 126 to the ISS 100, the data collection module 102 can mine for data contained in such contact/scheduling management systems 124 and other databases/third party systems 126. For example, the data collection module 102 may institute a search for all information relevant to a particular information source 120, such as published articles about a particular individual, for inclusion of the data as part of the data associated with an identifier. The data collection module 102 may collect and organize such data prior to storing the data in the main database module 104.

Additionally, in a similar manner as information may be gathered or obtained from the contact/scheduling management system 124, information may be gathered or obtained from a contact/scheduling client 140 or the contact/scheduling management module 108, which may optionally be included as part of the ISS 100.

Once the ISS 100 main database module 104 is populated and is associated with identifiers, the data may be retrieved from the ISS 100 main database module 104 using the identifier assigned to the stored data. As described above, the data may be retrieved from the ISS 100 using an information client interface application 132, which may be a web-interface. In this example, the web-interface may be part of the information client interface 132, which may be part of the data dissemination module 106. Data may also be retrieved via the information client interface 132 from contact/scheduling management systems 134, navigation systems 134, which may include a stand alone navigation system, navigation program, in-car navigation system or a cell phone navigation system, or other databases or third party systems 138, which may include, but not be limited to, any database or system that stores data on computers, servers, personal digital assistants, telephones, including but not limited to cellular telephones, televisions, vehicle control units, including navigation systems, or any other similar devices or systems, including, but not limited to, handheld devices and electronic storage devices, all of which may access the ISS 100 directly, or through networks, including but not limited to the Internet.

In the same manner that a contact/scheduling management system 134, navigation system 136 and other databases/third party systems 138 may obtain information from the ISS 100, the ISS 100 may provide information to such contact/scheduling management system 134, navigation system 136 and other databases/third party systems 138, for example, to up date prior information provided by the ISS.

Similarly, in a similar manner as information may be gathered or obtained by the contact/scheduling management system 134, information may be gathered or obtained from a contact/scheduling client 140 or the contact/scheduling management module 108, which may optionally be included as part of the ISS 100. Information can be gathered or obtained from any of these sources by, for example, using Microsoft® Exchange Server or other similar program to synchronize information.

Additionally, all the databases, systems, modules and interfaces used to provide information to the ISS 100 such as the contact/scheduling management systems 124, other databases/third party systems 126, information source interface 122 and information source 120 may be integrated with its counterparts used to gather information from the ISS 100, including, but not limited to, the navigation system 136, contact/scheduling management system 134, other databases/third party systems 138, information client interface 132 and information client 130.

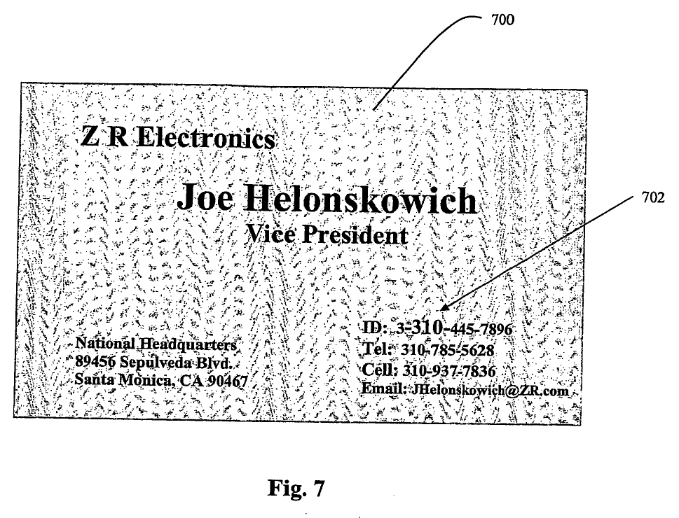

In practice, companies and/or individuals may provide others with identifiers, for example, contact identifiers to allow persons to obtain contact information using the ISS 100. By way of example, contact identifiers could be included on business cards to allow easy download on contact information contained on the business card into a persons' contact management software. FIG. 7 illustrates one example of a business card 700 that includes a contact identifier 702, which is shown as 3-310-445-7896. Commercial business card readers may be programmed to look for the identifier and retrieve the associated data. A bar code, RFID or other type of means may also be added to the business card to simplify scanning and inputting of the identifier.

Once in possession of this identifier, a person may be able to access the ISS 100 web interface, which could take the form of an information client interface 132 or which may be integrated into the data dissemination module 106. The web interface could, for example, provide users with a “GET INFORMATION” selection. If this option is selected, the user may then be taken to a screen that asks the user to input the identifier. Once entered, the ISS 100 could display the information to the user to confirm that the requested information is the desired information. From there, the ISS 100 may provide the user with the option of sending the information to themselves in the form of an email, a text message, a V-Card attached to an email, a word document, or another other desirable electronic format for receiving the data. Optionally, the user requesting the information may also be able to register with the ISS 100. As a registered user, the user maybe able to save forms, documents or other personalized templates, such as mailing labels, envelopes and etc. Upon entering the identifier, the user can select a desired template and the ISS 100 can populate the template with the information. The user can then save the populated template locally for future use. This feature may be helpful with assuring that a person is populating contact information on letters, faxes, and etc with current and accurate data.

Alternatively or additionally, any user application can be designed to include features to allow data retrieval from the ISS 100. Such user application can allow interface with application designed to provide the application with access to, and use of, ISS 100 information. For example, Microsoft® Outlooks could include a built-on or add-on functionality that would populate a contact file or add a contact file using a data identifier. The data identifier can be displayed as part of the contact information for a certain company or individual or stored with the contact information. In this manner, whenever the contact information is accessed, the information can be updated, if necessary, by accessing the ISS 100 main database module 104 and recording any changes. Optionally, the contact information can always be retrieved from the ISS 100 when accessed. In this case, it may not be necessary to store contact information locally.

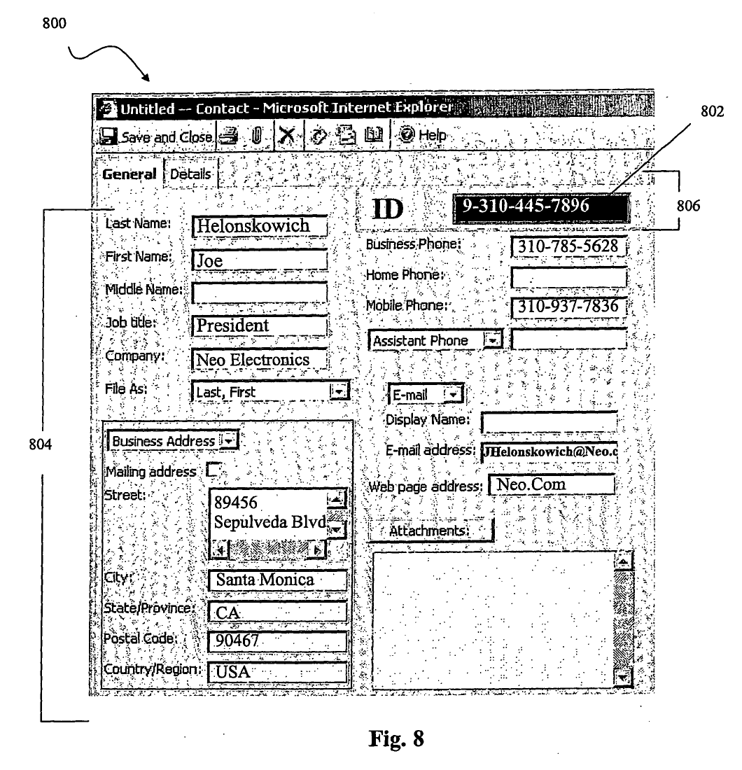

FIG. 8 is one example of one implementation of how contact management software 800, such as Microsoft® Outlook®, may be enhanced by using identifiers to retrieve information from an ISS 100. In this example, by inputting the identifier 802, the associated information 804 is retrieved and different fields may then be populated. In case the identifier is one of the fields such as telephone number or email, addition of extra field for inputting the identifier 806 is not necessary. Only telephone number or email need to be inputted in the corresponding field and the rest of the information may be retrieved from the ISS 100 by treating the telephone number or email as the identifier.

Similarly, a calendar management system could include a built-on or add-on function that would populate the calendar with event information upon receipt of an identifier associated with an event. The system may also be able to accept any type of data identifier and store the information in the relevant management tool. Further, word processing or document generation programs could allow for the entry of an identifier to populate the documents with accurate contact, event or other types of information.

This data retrieval function can be utilized in connection with any application that requires the input of contact data or event data by a user, including but not limited to, contact/scheduling management programs, word processing programs, and navigations systems. Further, these applications can run on, or be accessible by, personal computers, personal digital assistants, telephones, including but not limited to cellular telephones, televisions, vehicle control units, including navigation systems, or any other similar devices or systems, including, but not limited to, handheld devices and electronic storage devices.

As indicated above, the ISS 100 may also be able to allow users to associate metadata with an identifier. This may include any type of information that might be desired to be accessed and retrieved by a person. By associating metadata with identifiers, an ISS 100 user may also be able to create a personalized account that would allow the user to compile and receive certain metadata in a given format. For example, companies may provide weekly or daily specials in the form of metadata A user can then request that all the information associated with a number of identifiers be complied into one document and received by the user. In this manner, a user may be able to receive one .pdf file, for example, that includes all the daily adds for the user's five favorite stores. The user could then create personalized documents, or papers, generated from information compiled from the user's favorite sources.

A hyperlink, menu selection or button may start or initiate the retrieval of data through the ISS 100 using an identifier. A similar hyperlink may be attached to an email, displayed on a website or provided to a user in another manner. When selected, the hyperlink would retrieve the associated data from the ISS 100 and add the data to the relevant user's application, such as a contact manager database application. The selection of the hyperlink could also create a V-card or equivalent and email the V-card to the users identified destination. Other options may be provided to the user by right clicking on an identifier in any program including viewing or initiating the retrieval of data. An identifier may be communicated via variety of methods including but not limited to email, text message, instant message etc. A program such as an information client interface 132 may be devised to analyze the content of a document or file such as an email, text message or instant message and in case it contains an identifier, give the user the ability to retrieve and/or store the associated data.

With respect to event data, an application or user could utilize an identifier to receive event data that could be automatically populated on one's calendar. Further, an ISS 100 user may establish an account with the ISS 100 that would allow third parties to log events and reminders on a calendar that is synchronized with the user's personal calendar. Service providers and venders, such as doctors, travel agencies/sites, and dentists, could then place events and reminders on individual's calendars through utilizing the identifier to access an individual's ISS 100 account. These types of accounts may have multiple passwords with variety of access privileges. The information added by a third party may be presented to the main user and only added when confirmed. Such measures would further provide additional security. The service provider may also be informed when the user accepts the information.

In one example of one implementation, an information client 130 or an information client interface 132 may register with a data dissemination module 106 asking to be notified if the data associated with an identifier is modified. Alternatively, a data dissemination module 106 may automatically notify all the accessible information clients 130 or information client interfaces 132 that have accessed a certain identifier when the information associated with that identifier is modified.

### I. ISS Use of Identifiers

As recognized above, the invention may be implemented in a number of different implementations include a number of different modules and interfaces, permitting the interfacing to various databases, applications and with users of the ISS 100. Any implementation that is allows a first party to enter and record specific information provided by to the first party and that then allows a second party to retrieve information using an identifier associated with the data is within the scope of this invention.

An identifier may be associated with any type of data, including, but not limited to, contact information, event information, personal information, such as medical or financial records, and other information. Further, more than one identifier may be associated with the same information or the information can be segmented such that certain of the information may be associated with one identifier and other information may be associated with a separate identifier. The associated data may or may not overlap with other identifiers. As further explained below, in addition to associating data with an identifier, the data may further be associated with one or more security codes that prevent the release of all or part of the data associated with the identifier unless the person requesting the information provides the security code(s), as well as the identifier, when requesting associated data.

To retrieve data associated with an identifier, the identifier may be provided to a person who desires to retrieve the associated data. The identifier may be verbally provide to a person, may be provided to a person in writing, in the form, for example of a business card, print, newspaper, magazine, radio or television, or may be disseminate electronically in the form of an email, electronic document, screen display or etc. The identifier may be displayed in text or may take the form of a link that will allow the user to automatically retrieve associated data by selecting the identifier, for example, by double clicking on the identifier. Once the data is retrieved, it may be saved by the user manually or automatically in a program or application appropriate for processing and/or storing the retrieved data.

As one example, data associated with an identifier may be retrieved, stored, processed and reassembled by a website, program or software module designed to specifically retrieve information related to an identifier for use by the person requesting the associated information. For example, the data may be retrieved utilizing a program to retrieve the information associated with the identifier upon the entry of an identifier in the program. The program may be in a language such as Java and may represent part or all of an information client 130, information client interface 132 or data dissemination module 106 (see FIGS. 1-6). The program may be accessible locally on a user's personal computer, personal digital assistant, telephone, including but not limited to cellular telephones, television, vehicle control unit, including navigation systems, or any other similar devices or systems, including, but not limited to, handheld devices and electronic storage devices. Additionally, such programs may be accessible remotely using a web browser that is available on any of the above listed storage devices.

In this example, the manner in which the associated data may be used, processed, presented and stored may be at least partially determined by this program. For example, this program may be able to identify the type of data and recognize how to process, store and present the data to the requester. The associated data, when retrieved by the program may, for example, include as part of the data string, identifying information that informs the retrieving program of the type of data. For example, the data string may include identifying data that will allow the program to distinguishing contact data from event data, for example.

Additionally, in one example of one implementation, the construction of an identifier, in addition to or exclusive of the associated data, may provide information to the program responsible for retrieving, displaying, storing and/or processing the data regarding how the associated information may need to be handled. For example, all identifiers could be made up of equal length number sequences. The identifiers, by way of example only, could be similar in construction to telephone numbers, but constructed to exclude, telephone numbers. Different number ranges may be set aside for different type of information (e.g. Contact, Address, Group Contact, Event etc.). A simple cell phone interface may be used to enter a telephone number to be dialed or and identifier. In this regard, there would be no need to invoke another program or go to a different area in the phone for different applications to enter an identifier. Due to the structure of the identifier, an identifier could be distinguished between other types of data entry numbers, such as a phone number. Thus, when a series of numbers is entered into a cell phone, it could be determined if the series of numbers represent a telephone number, in which case the number is dialed. However, if the number is an identifier, an ISS 100 may be accessed, associated information retrieved and/or saved. The numbering range of the identifier may be used to assist in determining what needs to be done with the data. In a sense, in this example, not only the identifier is used as data but also command. Alternatively, the associated data to an identifier may also be used to determine the course of action. For example the associated data may include a “Type” field or other data string that will identify the type of associated data that is being retrieved or send to the requesting program. Further, the associated data may include other fields that instruct an information client 130 or an information client interface 132 (see FIGS. 1-6) how to handle the data. Symbols, such as ‘W’, may also be used to distinguish the number from a telephone number.

In general, each identifier may have a type associated with it. Persons skilled in the art will understand and appreciate that the data structures outlined here are for presentation and reference only. Many other data structures are possible and well understood. In one example of one implementation, an entity's identifier may be the telephone number for the entity plus an additional or alternate character. For example, a company having a 1-800-555-1234 may have 2-800-555-1234 as its identifier. This will make the numbers mutually exclusive but at the same time make it easy to remember and reduce the number of numbers to remember. Further, the identifiers may include a character or number that identifies whether the number is associated with a product, and event, personal information, group of companies, group of individuals, etc. As previously referenced, examples of types of data identifiers and how they may be generated can be found in PCT International Patent Application No. PCT/US2005/025241 titled “Location Codes for Destination Routing”, which application is incorporated in its entirety into this application.

### II. ISS Application Examples

Following are various application examples of several different implementation of the invention.

A. Address Data

Using FIG. 6 as reference, in one example of one implementation, the data provided by an information source 120 to a data collection module 102 may be as follows:

| Field Name | Data |
|---|---|
| Street Number | 12345 |
| Street Name | Main Ave. |
| City | Los Angeles |
| State | CA |
| Zip | 91202 |

Here, an identifier may be assigned to the data based on an algorithm. The algorithm uses the telephone area code that the address belongs to as part of the identifier, and assigns the next available free number. Here for example the identifier could be #818-543-9876, where (818) is the area code associated with the address. Alternatively, the identifier may be assigned utilizing another method, may be randomly selected by the ISS 100 or may be selected by the information source 120 among other methods.

The above data in conjunction with the identifier may then be saved in the main database module 104. When an information client 130 sends the identifier (#818-543-9876), the data dissemination module 106 may then return all or part of the above data.

To retrieve the information, by way of example, an information client interface 132 acting as a “Master” enables a user to input an identifier. The information client interface 132 forwards the identifier to the data dissemination module 106. The data dissemination module 106 cross references the identifier, retrieves the associated data and forwards it to the information client interface 132. The information client interface 132 after allowing the user to verify the address may forward the address information to a program for processing, such as a navigation system 136 to create routing information using the address information associated with the identifier as the destination address.

B. Contact Data

Using FIG. 6 as reference, in one example of one implementation, the data provided by an information source 120 to a data collection module 102 may be as follows:

| Field Name | Data |
|---|---|
| Name | John |
| Last Name | Doe |
| Company | Radio R US |
| Title | Senior sales representative |
| Tel | (310) 879-2787 |
| Email | JD@RDU.com |
| Street Number | 76280 |
| Street Name | First Street |
| City | Santa Monica |
| State | CA |
| Zip | 90123 |

Here, a series of identifiers may be provided to the user to choose from. Alternatively, the identifier may be assigned to the data based on an algorithm, may be assigned utilizing another method, may be randomly selected by the ISS 100 or may be selected by the information source 120. The assignment of the identifier would include a means for checking to confirm that duplicate identifiers are not being assigned. The above data, in conjunction with the chosen identifier, may be saved in the main database module 104. An information client interface 132 acting as a “Master” may enable a user to input an identifier. The information client interface 132 forwards the identifier to the data dissemination module 106. The data dissemination module 106 cross references the identifier, retrieves the associated data and forwards it to the information client interface 132. The information client interface 132 after allowing the user to verify the contact data, formats it in a format recognizable by the particular contact/scheduling management system 134 and adds the contact to its database. In another example of an implementation, only a reference to the contact is saved in the contact manager. In this example, identifier associated with the contact is used to retrieve the latest information from the ISS 100.

C. Contact Data in Multiple Languages

Using FIG. 6 as reference, in one example of one implementation, the data provided by an information source 120 to a data collection module 102 may include data associated with the following fields:
Field Name
Name (English)
Last Name (English)
Company (English)
Title (English)
Card Bitmap (English)
Tel
Email
Name (Japanese)
Last Name (Japanese)
Company (Japanese)
Title (Japanese)
Card Bitmap (Japanese)

Here, an identifier that matches the contact email address may be assigned to the contact. Alternatively, an identifier may be assigned to the data based on an algorithm, may be assigned utilizing another method, may be randomly selected by the ISS 100 or may be selected by the information source 120. The above data, in conjunction with the chosen identifier, may then be saved in the main database module 104. An information client interface 132 acting as a “Master” may enable a user to input an identifier. The information client interface 132 may also have preferences for language. Here, in this example, the user has set the language to English. The information client interface 132 forwards the identifier along with English as the preferred language to data dissemination module 106. The data dissemination module 106 cross references the identifier, retrieves the associated data and processes the data by filtering non-English fields and forwards it to the information client interface 132. The telephone and email data, which are not language specific, may be sent too. The information client interface 132, after allowing the user to verify the contact data, may format the data in a format recognizable by the particular contact/scheduling management system 134 and may add the data as a contact to the management system 134 database. Alternatively, in another example, information may be translated automatically online or offline where it may be added to the database.

D. Group Contact Data

Using FIG. 6 as reference, in one example of one implementation, the data provided by an information source 120 to a data collection module 102 may include data associated with the following fields:
Field Name
Group Name
Name 1
Address 1
Tel 1
Email 1
Name 2
Address 2
Tel 2
Email 2
. . . .
. . . .
. . . .
Name n
Address n
Tel n
Email n
Personal Contact ID(n)
Personal Contact ID(n+1)

This data may belong to a group that has multiple members. Here, an identifier may be assigned to the data based on an algorithm, may be assigned utilizing another method, may be randomly selected by the ISS 100 or may be selected by the information source 120. Further, an identifier may be assigned, in addition to the group data, to each group member. The above data, in conjunction with the identifier, are saved in the main database module 104.

When an information client 130 sends the identifier, the data of the whole group may be retrieved by the data dissemination module 106. Using one identifier, a client, such as a new member, may be able to retrieve and/or save the contact information for the whole group. Alternatively, a group identifier may include other identifiers. Here, for example, rather than including Name, Address, Tel and Email of an individual, his/her personal contact identifier may also be included as part of the group data, allowing for the information client 130 to retrieve data for only a group member.

E. Group Address Data

Using FIG. 6 as reference, in one example of one implementation, the data provided by an information source 120 to a data collection module 102 may include data associated with the following fields:

Field Name
Company Name, website
Address 1, Tel 1
Address 2, Tel 2
Address 3, Tel 3
. . . .
Address n, Tel n

This data may belong to a company that has multiple branches. Here, an identifier may be assigned to the data based on an algorithm, may be assigned utilizing another method, may be randomly selected by the ISS 100 or may be selected by the information source 120. The above data in conjunction with the identifier may be saved in the main database module 104.

When an information client 130 sends the identifier, it may also send the current location of the user or a reference location as well as a mode of response (in this case a text message). The data dissemination module 106 cross references the identifier, retrieves the associated data. When the program interfacing with the data dissemination module 106 or the information client interface 132 is a navigation system 136, the information client interface 132 or the data dissemination module 106 may process the retrieved data by finding the closest branch or affiliated company location (or a number of closest branches or locations).

F. Event Data

Using FIG. 6 as reference, in one example of one implementation, the data provided by an information source 120 to a data collection module 102 may be as follows:

| Field Name | Data |
|---|---|
| Event Name | Graduation Ceremony |
| Owner/Sponsor | Washington High School |
| Price | Free Admission |
| Start Date | Jan. 05, 2004 |
| Start Time | 1:30 PM |
| End Date | Jan. 05, 2004 |
| End Time | 3:30 PM |
| Street Number | 987 |
| Street Name | Wilshire Blvd |
| City | Beverly Hills |
| State | CA |
| Zip | 90214 |

Here, an available identifier is assigned to the data. The identifier may be assigned based on an algorithm or utilizing another method, may be randomly selected by the ISS 100 or may be selected by the information source 120. The above data, in conjunction with the chosen identifier, may be saved in the main database module 104. An information client interface acting as a “Master” may enable a user to input an identifier. The information client interface 132 may forward the identifier to the data dissemination module 106. The data dissemination module 106 may cross references the identifier, retrieve the associated data and forward it to the information client interface 132. The information client interface 132, after allowing the user to verify the contact data, may format the data in a format recognizable by the particular contact/scheduling management system 134 and add the event to the calendar. The information client interface 132 may be provided with the capability to request to be informed if there is a change in the event. In this case, data dissemination module 106 may register the information client interface 132, monitor the database and if the particular event is changed, inform the information client interface 132.

G. Multi-Period Event Data

Using FIG. 6 as reference, in one example of one implementation, the data provided by an information source 120 to a data collection module 102 may be as follows:

| Field Name | Data |
|---|---|
| Event Name | 3-Day Real Estate Seminar |
| Location | LA convention center |
| Owner | Coldwell Banker |
| Price | $75.00 per ticket |
| Start Date1 | Feb. 15, 2004 |
| Start Time1 | 10:30 AM |
| End Date1 | Feb. 15, 2004 |
| End Time1 | 3:30 PM |
| Start Date2 | Feb. 16, 2004 |
| Start Time2 | 9:00 AM |
| End Date2 | Feb. 16, 2004 |
| End Time2 | 12:30 PM |
| Start Date3 | Feb. 17, 2004 |
| Start Time3 | 3:30 PM |
| End Date3 | Feb. 17, 2004 |
| End Time3 | 5:30 PM |

Here, an available identifier may be assigned to the data. The identifier may be assigned based on an algorithm or utilizing another method, may be randomly selected by the ISS 100 or may be selected by the information source 120. The above data, in conjunction with the chosen identifier, may then be saved in the main database module 104. An information client interface 132 acting as a “Master” may enable a user to input an identifier. The information client interface 132 forwards the identifier to the data dissemination module 106. The data dissemination module 106 cross references the identifier, retrieves the associated data and forwards it to the information client interface 132. The information client interface 132, after allowing the user to verify the event data, may format the event data in a format recognizable by a particular contact/scheduling management system 134 and may add all the events associated with the identifier to the calendar. Alternatively, a user may be given the ability to pick and choose between the events associated with the identifier to be added to a contact/scheduling management system 134 and may register to be notified if a particular event is changed (as described above).

H. Multi-Session Event Data

Using FIG. 6 as reference, in one example of one implementation, the data provided by an information source 120 to a data collection module 102 may be as follows:

| Field Name | Data |
|---|---|
| Event Name | Comedy hour |
| Location | Main Hall |
| Owner/Sponsor | Laugh Factory |
| Price | $25.00 per ticket |
| Start Date (EA1) | Feb. 15, 2004 |
| Start Time (EA1) | 10:30 AM |
| End Date (EA1) | Feb. 15, 2004 |
| End Time (EA1) | 11:30 PM |
| Start Date (EA2) | Feb. 16, 2004 |
| Start Time (EA2) | 9:00 AM |
| End Date (EA2) | Feb. 16, 2004 |
| End Time (EA2) | 10:00 AM |
| Start Date (EA3) | Feb. 17, 2004 |
| Start Time (EA3) | 3:30 PM |
| End Date (EA3) | Feb. 17, 2004 |
| End Time (EA3) | 4:30 PM |

In this example, the three sessions are equivalent (hence “E”) and their type is “A”. Here, an available identifier may be assigned to the event. The identifier may be assigned based on an algorithm or utilizing another method, may be randomly selected by the ISS 100 or may be selected by the information source 120. The above data in conjunction with the chosen identifier are saved in the main database module 104. An information client interface 132 acting as a “Master” may enable a user to input an identifier. The information client interface 132 forwards the identifier to the data dissemination module 106. The data dissemination module 106 cross references the identifier, retrieves the associated data, processes the data by finding the next available session or series of sessions using the current date and time or a date and time and provides and forwards the data to the information client interface 132. The information client interface 132 after allowing the user to verify the event data, formats it in a format recognizable by the particular contact/scheduling management system 134 and adds the chosen session to the calendar. The information client interface 132 may ask for multiple or all of the sessions so it would give the user ability to choose the desired session with more control. A multi-period event may also be a multi-session event. The user may also be given the ability to obtain a list of events at or after a specific date/time, for example, by using a calendar.

I. Using Security Code

Using FIG. 6 as reference, in one example of one implementation, the data provided by an information source 120 to a data collection module 102 may include data associated with the following fields:
Field Name
First Name
Last Name
Company Name
Company Address
Company Tel
Home Fax (SC1)
Home Address (SC1, SC2)
Home Phone (SC2)

Here, a series of identifiers may be provided to the user to select from to assign an identifier to the data. Alternatively, the identifier may be assigned based on an algorithm or utilizing another method, may be randomly selected by the ISS 100 or may be selected by the information source 120. Security Code 1 (SC1) and Security Code 2 (SC2) may be chosen and entered by the user or may be assigned by the ISS 100. The above data, in conjunction with the chosen identifier and security codes, may then be saved in the main database module 104.

In this example, all or part of the data may be protected by one or more security codes. In order for a user to retrieve the protected data, the user must know the security code associated with the data as well as an identifier. For example, the owner of certain data may want to control the release of the data. Thus, the owner of the data will protect the data with a security code. In one example of an implementation, even contact data may be protected by a data owner using a security code. This is example, an information client interface 132 acting as a “easter” may enable a user to input an identifier as well as optional security code. The information client interface 132 may then forward the identifier, as well as a security code, with a request for information, such as a V-CARD, to the data dissemination module 106. Data dissemination module 106 cross references the identifier, retrieves the associated data, processes the data based on the provided security code and then forwards it to the information client interface 132. If no security code is provided, the data dissemination module 106 may return (First Name, Last Name, Company Name, Company Address, and Company Telephone Number). If SC1 is provided in addition to the identifier, the Home Address of the data owner may also be provided. If SC2 is provided, the Home Telephone number of the data owner may also be provided. In this example, the data dissemination module 106 may provide the data to the information client interface 132 in the form of an email with a V-CARD attached to the email. Information associated with different security codes could be mutually exclusive, inclusive or overlapping.

When data is protected by a security code, access to the data may be restricted by the system if an identifier is accessed several times by the same person or entity entering different security codes. Access to data protected by a security code may further be restricted if multiple failed attempts are made to access data associated with a particular identifier within a specified or predetermined period of time. In either case, the system may notify the owner of the identifier of the failed attempts. Access may then be restricted by the person or entity making several failed attempts or may be completely restricted until the data owner changes the security code. Properties for denying access to information after failed attempts to enter associated security codes may be determined by system settings, policies or by user preferences.

Additionally, when a security code is used in connection with an identifier, the system may include mechanisms for resetting the security when a breach is threatened, as described above, or as desired by the user. For example, the data owner may desire to manually changing the security code from time to time by being prompted by the system to change the code based upon certain parameters, such as the passage of time.

### III. Examples of ISS Implementations

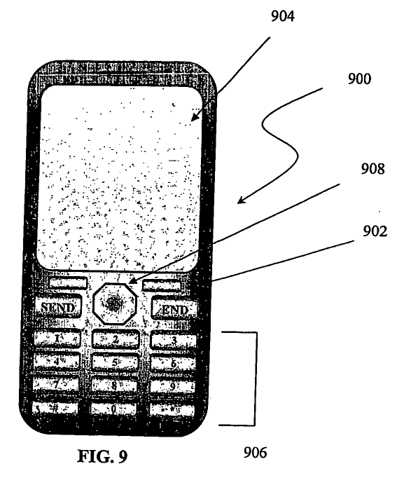

FIGS. 9 to 23 below illustrate various examples of different implementation for the use of an ISS in connection with cellular telephones and/or navigation system, which may include a stand alone navigation system, navigation program, in-car navigation system or a cell phone navigation system. While the illustrated implementations are shown in connection with the use of cellular telephones or navigation systems, those skilled in the art will recognize that the ISS 100 of the invention may be utilized in connection with any electronic device, including but not limited to, electronic handheld devices, such as PDA or other storage devices, computers, servers, GPS systems, navigation system, any type of program(s) etc.

As previously discussed, the data collections module 102 or data dissemination module 106 may be accessible via a cell phone or navigation system using a local program, which serves as the information source interface 122 and information client interface 132, respectively. Due to the large number of cell phone platforms, when utilizing a cell phone, it may be desirable to access such programs remotely using a web browser available on the cell phone.

For purposes of illustration only, FIG. 9 is provided that illustrates an example of a user interface of a cellular telephone 900. In this example, the cell phone 900 has a keypad 902 and a screen 904. The keypad 902 consists of a numeric area 906, mouse key 908, SEND, END, CLR, S1 and S2 soft keys. The mouse key 908 can be pressed in four directions (up, down, left and right) and has an action “OK” key in the middle.

FIGS. 10 through 17 illustrate a few examples of implementation of how identifiers can be used in connection with contact/scheduling programs, navigation programs and/or other programs as used with a cell phone 900. In one example, the cell phone 900 may have the ability to communicate with a server, which may be accessible through the web via a web browser resident to the cell phone.

FIG. 10a illustrates an example of a business card 1000 displaying an associated identifier 1002 referenced as “9-310-333-3000.” In this example, the characters “GC” are placed on front of the identifier to assist users with locating and recognizing the identifier. FIG. 10b illustrates an example of one input screen that may be displayed on a cell phone to interface with an ISS 100. In this example, the user may first enter an identifier into the cell phone 900 using the keypad 902. Once the identifier is entered, the user may then press the “SEND” key, which will send the requested identifier to a server to retrieve associated data, if the data is not available locally. The server may then retrieve the data in a database associated with the identifier and forward the corresponding associated data to the cell phone 900, which may be then displayed to the user for verification.

FIG. 10c illustrates an example of one screen display that may be utilized to present the corresponding associated data to the user for verification. In some implementations, this data may be available in different languages. Depending on user preferences, only the data in a specified language may be retrieved. For example, the same information may be presented in Japanese in response to the same identifier. In this example, the identifier corresponds to data on the business card in FIG. 10a. Once displayed, the cell phone user may then press the “S1” key to add the data to the user's contact database. FIG. 10d illustrates an example of a screen display acknowledging that the data has been added to a cell phone user's contact database. This database may be located locally, on the cell phone, or may be remotely accessible through a network.

Alternatively, the user may select the “S2” key on the cell phone, selecting the Navigation option, which may calculate the route to the address associated with the identifier. FIG. 10e illustrates a screen display that may be presented when the Navigation option is selected that maps the route to the address associated with the data.

FIG. 11a illustrates an example of a business card 1000 displaying an associated identifier 1002 referenced as “GC: 9-310-333-3000” and including a security code 1100, which in this example, is handwritten on the card by the card holder. FIG. 11b illustrates one example of one implementation of an input screen for receiving an identifier and a security code. In this example, the user, in addition to the identifier of previous example (9-310-333-3000), enters a security code (357) shown by (***). Once the identifier is entered, the user may then press the “SEND” key, which will send the requested identifier to the server to retrieve associated data if the data is not available local to the cell phone. The server may then retrieve data associated with the identifier in the database and forward the corresponding associated data to the phone, which may then be displayed to the user for verification. FIG. 11c illustrates an example of one screen display that may be utilized to present corresponding associated data to a user for verification. The user may add this information to a contact manager by pressing S1 or may generate routing information by selecting S2 (as illustrated in FIG. 10e). Further, the user may view further data associated with this identifier by using the scroll bar on the left side of the screen. FIG. 11d illustrates additional information that may be viewed by using the scroll bar. In this example, compared to the previous example of FIG. 10c, the server provides additional data, i.e., Home Address, Home Tel: “818-768-9876” and Personal Email, which is obtained through the use of the security code.

As illustrated in FIG. 11d, the data provided by the server that may correspond to the identifier and security code is not a superset of the data for the identifier alone but overlaps the data. In yet other examples, the data corresponding to an identifier and a security code may not overlap with the data retrieved absent the use of a security code.

As illustrated in FIGS. 11d & e, when the telephone number associated with the data is highlighted, a cell phone user can automatically initiate a call to the number by selecting the highlighted number. FIG. 11e illustrates a screen display showing the automatic dialing of the chosen telephone number associated with the identifier.

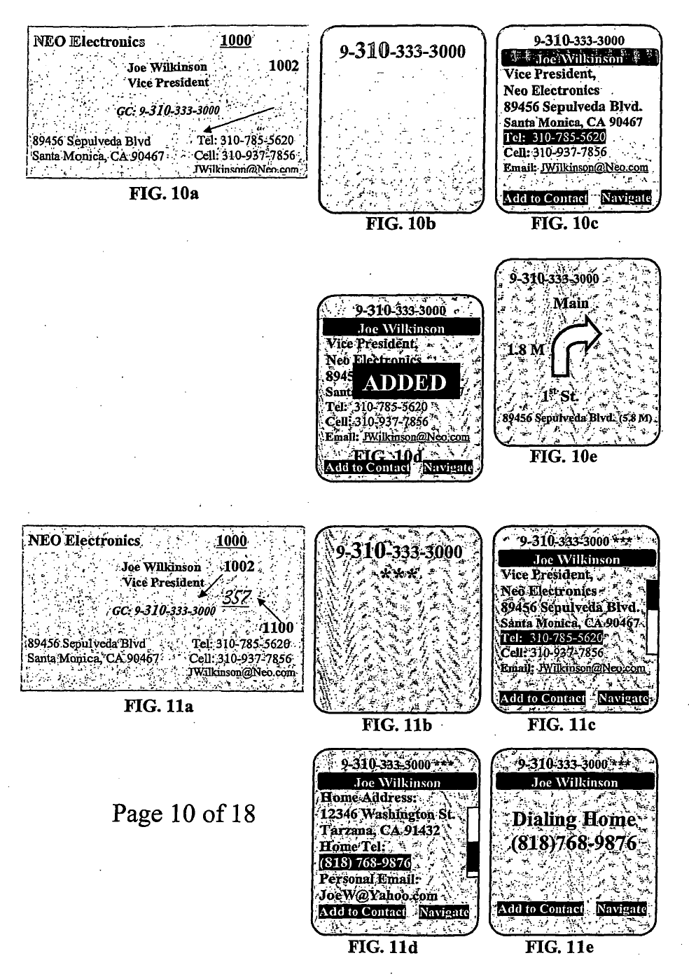

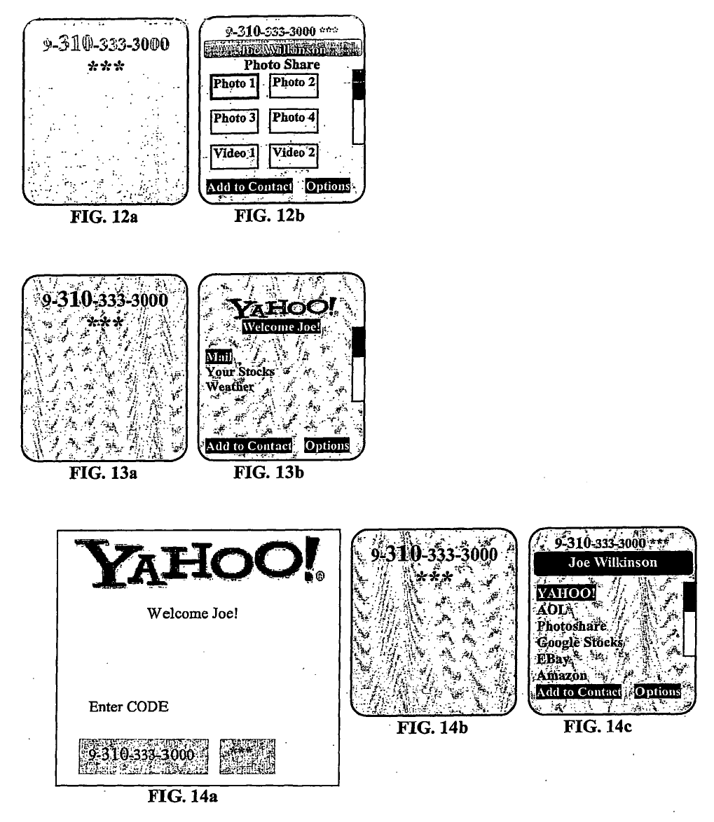

FIG. 12a illustrates one example of an input screen for receiving an identifier and a security code. In this example, it is illustrated that a particular security code associated with an identifier may retrieve photos, videos or both for the purposes of sharing with others. FIG. 12b illustrates an example of one screen display that may be utilized to present the corresponding associated photos and/or videos for the user to save, download, share or perform other common tasks associated with photo and/or video sharing. Although not illustrates, audio, other multimedia files, and other metadata may also be shared in a similar manner. Although this example illustrates the retrieval of the media files with the use of a security code, it is not necessary that the media files be secured data. Media files may be made publicly available along with contact information or other similar information accessible through the use of an identifier alone. For example, individuals may desire to include head shots with publicly available contact data.

FIG. 13a illustrates one example of an input screen for receiving an identifier and a security code. In this example, it is illustrated that a particular security code associated with an identifier may be used to access a user's personal account information via a website, such as initiating access to their personal Yahoo! ® account. Yahoo! ® is a registered trademark of Yahoo!, Inc. In this manner, the identifier and security code are associated with a website (which in this example is www.yahoo.com), a login name and a login password. FIG. 13b illustrates an example of one screen display that shows automatic access to a personal Yahoo!® account via the entry of an identifier with a particular security code. Thus, when a user enters an associated identifier and security code into the input screen, as illustrated in FIG. 13a, the system automatically accesses the website and logs the user into his or her web based account using the data associated with the identifier and security code. Although, in this example, the user is automatically logged into a personal account on a website, the identifier with security code may simply direct the user to a website, which may or may not be secured. For example, an individual may have a secured website that he or she desires to allow only certain individuals to access. In this case, an identifier with security code can direct an individual to access.

While FIGS. 13a & 13b illustrate the use of the entry of an identifier and security code into an input screen to access a website and personal account information related thereto, FIGS. 14a, b & c illustrate that an identifier and security code may also be used to access personal account information from entry of the information into a website. FIG. 14a illustrates a website that may include a request for entry of an identifier and security code. For illustrative purposes only, in this example, the website is www.yahoo.com, although any website may include an input for an identifier and/or security code as shown in FIG. 14a.

As illustrated, the website, such as Yahoo!®, may allow its members to input an identifier. Using the identifier and security code that is input into the website, the website may then retrieve the necessary information associated with the identifier and log the user on the website. For example, Yahoo! ® could retrieve the user name and password associated with the identifier, using the security code, and log the user into their personal Yahoo! ® account. The retrieval of this information may be performed locally or remotely, from a database maintained by Yahoo! ® or another third party.

Alternatively, an identifier and security code could be entered into an input screen, as illustrated in FIG. 14b, which shows one example of an input screen for receiving an identifier and a security code. Using the security code, the user may be able to access information related to all or a select few of their online personal accounts. FIG. 14c illustrates an example of one screen display showing various online accounts of the owner of the identifier and a list of websites that an owner may access. Such listing may be comprised entirely of online accounts, websites from a user's favorites lists, or a combination of both, among other information. By selecting any one of these listed sites, the system may automatically access the selected website and/or log the user into their personal account. In one example, the security code used in 14a and 14b may or may not be the same.

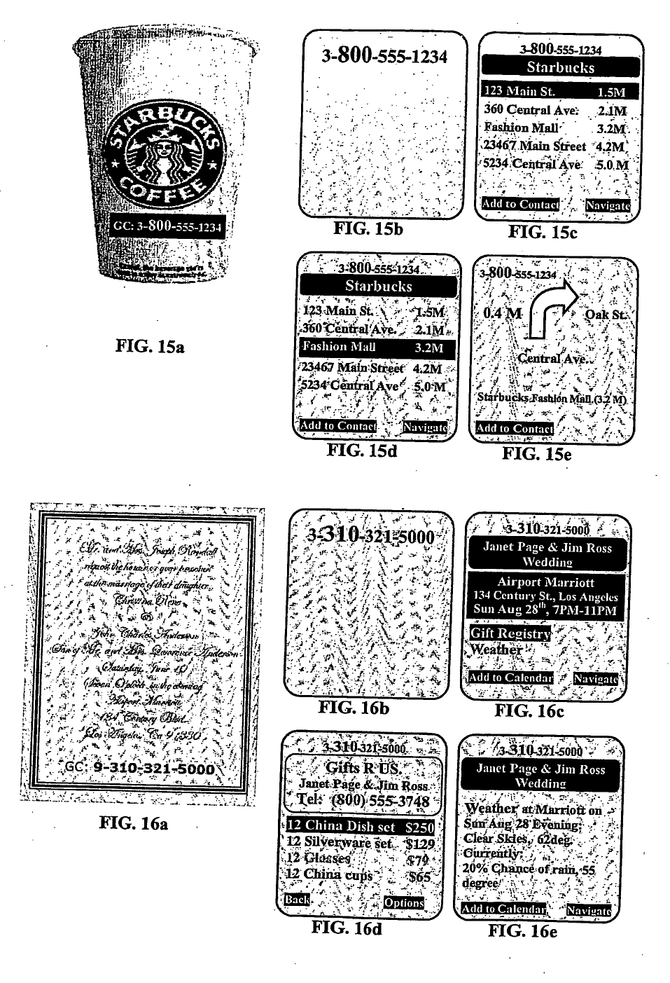

FIGS. 15a-15e illustrate another example of a function that may be performed by a navigation system of a cell phone using data associated with an identifier input into the cell phone. In this example, an identifier, representative of a group identifier, may be entered into the cell phone. FIG. 15a illustrates one example of how a group identifier for a particular company may be disseminated. In this example, a group identifier for a company, such as Starbucks®, may be provided on the company's coffee cups. Starbucks® is a registered trademark of Starbucks US Brands, LLC. As discussed previously, group address identifiers may generate information related to one entity or a collection of many entities that may be used to locate the most desirable location(s) of such collection of entities for the user.

FIG. 15b illustrates a screen display from the entry of a group identifier. In this example, the group identifier starts with “3-800”, which may operate as a prefix representative of a group identifier. When the “SEND” button is pressed, the identifier, in addition to the GPS coordinates of the cell phone, may be forwarded to a server if the required information is not available local to the cell phone. The server recognizes the group identifier and takes the current location of the cell phone user into account. From there, the server can identify one or more of the closest locations associated with the group identifier and can forward those locations to the cell phone for display.

FIG. 15c is an example of one screen that may be used to display the nearest locations associated with the group identifier entered by the user. As illustrated in FIG. 15c, the cell phone may then display the name of the company with a list of closest branches. The list of displayed locations may be utilized to calculate routing information or may be saved in the users contact database. For example, the “S1”, soft key may be used to add the company information to the user's contact management application or a select company's location information. Further, the name of the company (e.g. Starbucks®) may be selected in the contact management application and, when the send button is pressed, the name and/or the identifier, along with the GPS coordinates of the cell phone (or equivalent), may be sent to the server to get the nearest branches to the current location of the user.

In this example, the user may pick one of the locations. FIG. 15d illustrates a user selecting the Fashion Mall location. Then, by pressing the “S2” soft key, the corresponding address of the selected location may then be sent to a navigation program that can plot a course from the current position of the cell phone. FIG 15e illustrates an example of one screen displey showing routing information to the Fashion Mall location.

FIGS. 16a-16e illustrate one example of an implementation where an identifier associated with a specific event may be utilized in connection with an ISS 100 via a cell phone. FIG. 16a illustrates one example of how an identifier for a specific event may be utilized by including the event identifier on an invitation, such as a wedding invitation. FIG. 16b illustrates one example of a screen display that may be utilized to enter an identifier. Once entered into the screen display, the information associated with the identifier may be retrieved by pressing the “SEND” or “ENTER” button: When the “SEND” or “ENTER” button is pressed, the identifier may forward the request for associated information to the server if the information is not available locally.

FIG. 16c illustrates one example of particulars of an event associated with the identifier entered by the user. As illustrated in FIG. 16c, the address of the associated event, as well as other associated data, is retrieved upon entry of the identifier into the cell phone. If the associated data is not stored locally, the information may be returned by the server and displayed. Here, this is identified has an event with a specific date, start time and end time which may all be displayed for the user.

As illustrated in FIG. 16c, in this example, if the S1 “OPTION” key is pressed, the system may give the user the option of adding this event to their calendar, adding the identifier and the name associated with the identifier to their contact management application, viewing the forecast at the time of the event or finding out about nearby Points of Interests. If the option of “Add to Calendar” is chosen, this event may be added to the user's calendar marling August 28^{th} between 7 pm to 11 pm and a scheduled event on the user's calendar. This could be a local calendar, a calendar in a contact/scheduling database or a calendar associated with the main database module 104 of the ISS 100. A client/server relationship can be created to notify and change the event in the calendar if details of the event are changed. For example, if the wedding start time changes to 7:30, everyone that has chosen the option to input to their calendar may be notified of the change and their calendar may be manually or automatically updated. In this example, the identifier is associated with a hotel, which may also have a primary identifier and a series of additional identifiers for different events. In this example, if “Add to Contact” is selected, “Airport Marriott” will be added to the user's contact. Further, event attributes such as date, time and location may be used to processes the associated data.

As illustrated in FIG. 16c, additional information may also be obtained relating to the event, such as Gift Registry information, which may be used when the event is a wedding, shower or other similar event. Additionally, Weather information may also be retrieved, showing the current weather information for the event location or the predicted weather on the date of the event. If “Gift Registry” is selected, the location where the couple is registered may be displayed along with the items for which the couple registered. FIG. 16d illustrates one example of a screen display showing that the couple is registered at Gifts R US and the items listed on the couple's registry. The system may also provide a mechanism for purchasing items off the registry from the access screen.

If “Weather” option is chosen, a weather database can be accessed and the conditions for the event date “Aug. 28^{th}”, the event time “Evening” at the event place “Airport Marriott” as well as the current conditions at the event place may be retrieved and displayed. FIG. 16e illustrates one example of the acquisition of weather data related to event data associated with the identifier. This illustrates how event date and event time may be used in processing the data. Further, although not shown, in this example, if the “Nearby POI” is selected, the user may be presented with points of interest near the Airport Marriott. This is an example of how an event's location, date and time may be used to process other information and present it to the user. User preferences and other criteria may also be used to process information. An identifier, e.g., 211 may be used to get the weather information at the user location.

Although not illustrated, routing information may also be generated to the event by selecting the Navigate option on the display screen. Routing information may be generated from an identifier associated with an event by sending the corresponding address to a navigation program that plots a course from the current position. In this example, if the user selects the address of the location of the event, the address of the event may then be sent to a navigation program, along with the current location of the cell phone. The navigation system can then plot the course from the current position of the cell phone to the event location. RSVP may also be requested and sent.

FIGS. 17a-17d illustrate one example of an implementation utilizing an identifier associated with a group of individuals where the data regarding each individual includes the individuals' schedules. This type of identifier may be referred to as a compound identifier. FIG. 17a illustrates an example of a screen display that provides for the entry of an identifier associated with a group of individuals. When the “SEND” or “ENTER” button is pressed, the identifier may then be forwarded to the server if the information is not available locally to the cell phone.

In this example, the compound identifier is associated with data that includes group contact information and multi-period event information. FIG. 17b illustrates an example of a screen display showing the data associated with the compound identifier illustrated in FIG. 17a. In this example, the retrieved information displayed on the screen is a list of the individuals who are group members, as well as a group name. In this example, if the “S2” button on the cell phone is pressed, the user may then be presented with the schedule of the group. FIG. 17c illustrates an example of a screen display showing the group schedule. As illustrated, in this example, two (2) events are associated with the compound identifier. As shown, the first event, which is a weekly general meeting, takes place weekly during a 6 month period between March and August. In this example, if the “S1” option button on the cell phone is pressed, the user may be given a series of options for storing and/or processing the information displayed in FIG. 17c. FIG. 17d illustrates an example of a screen display showing various options available to a user regarding the displayed information in FIG. 17c. In this example, if “Add All” option is chosen by the user, all the contacts are added to the user's contact manager and all the events are added to the user's calendar. “Add Contacts” adds all the contacts to the contact manager, while “Add Events” adds all the events to the calendar. The user may also be given the option of adding individual contacts or events. “Delete All”, “Delete Contacts” (not show) and/or “Delete Events” (not shown) erases the named entities and associated events from the contact manager and/or the calendar.

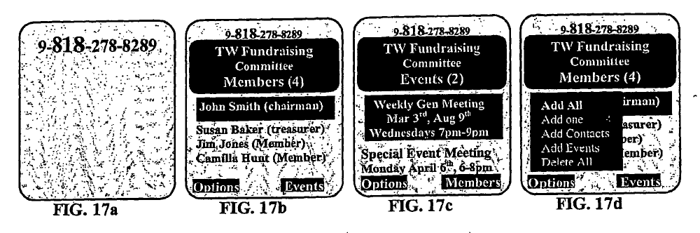

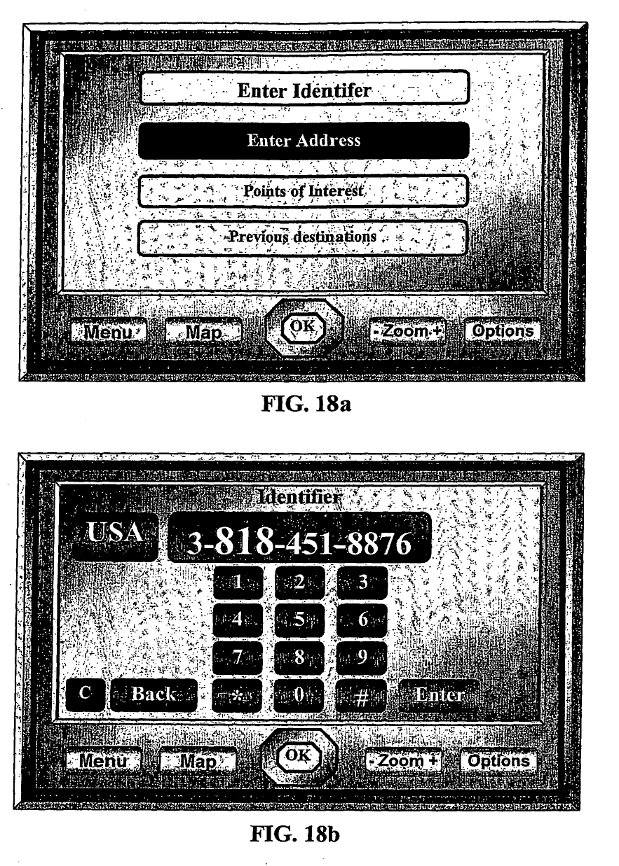

FIGS. 18a, 18b, & 18c, 19 & 20 illustrate various examples of different implementations of an in-car navigation system utilizing identifiers in connection with an ISS 100. As illustrated by FIG. 18a, the navigation system offers the user the option of utilizing identifiers for the input of the designation. As illustrated in FIG. 18a, using identifiers may be offered as one alternative means for the entry of destination information. In such system, the user still has the option to input address information. Alternatively, navigation systems may be developed that provide for the exclusive input of identifiers.

FIG. 18b illustrates an example screen for inputting an identifier. This screen would appear if the user selects the option of “Enter Identifier” from the list of options displayed on the screen illustrated in FIG. 18a. This selection may be made by using either a touch screen or up and down feature of the mouse and pressing “OK”. As illustrated in FIG. 18b, the user may then be provided with the ability to enter an identifier. In this example, the user may input the identifier using the numeric pad on the touch screen and then pressing “Enter”. The “C” button may be used to cancel the operation and the “Back” button may be used as backspace. Optionally, a button may be provided to restrict the field of the search using the identifier by country, state, city or other similarly restrictive identifiers. In this example, the database of searching is restricted to the US; however, if the “Country” button is pressed, the user will be presented with a list of countries to select from to changer the zone of searching. Alternatively, although not shown, the user can be given an opportunity to enter a country code to narrow the field of searching.

FIG. 18c illustrates one example of how associated data to an identifier may be displayed to a user in connection with the operation of a navigation system. In this example, the identifier belongs to a restaurant. The operation hours are compared to the real-time clock of the navigation system and it has been determined that this restaurant will be open for another 2:30 hours. This information may be added to the contact manager by pressing “Add to Contact” button. In an alternative implementation, this page may be assembled by an ISS 100 and sent to the navigation system 136 to be displayed for example in form of a XHTML page. This may include calculation and inclusion of “Open for another 2:30 hours”.

FIG. 19 illustrates one example of how associated data to an identifier may be displayed to a user in connection with the operation of a navigation system. In this case, the associated data may include the agent, telephone number, specification of the property, a photo and the fact that there is more data available if desired. It should be noted again that this data might be available locally or downloaded in real-time right after the user inputs the identifier and presses “Enter”. This information may be added to the contact manager by pressing “Add to Contact” button.

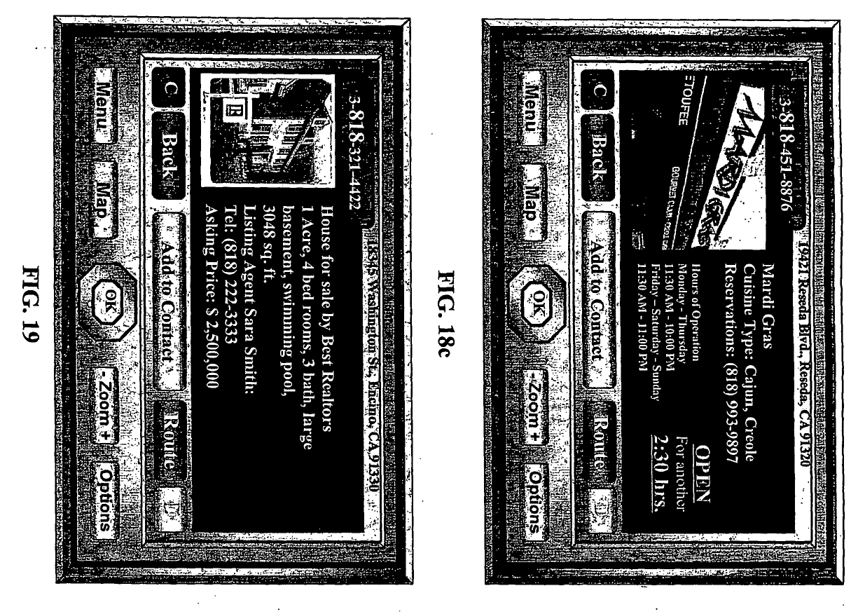

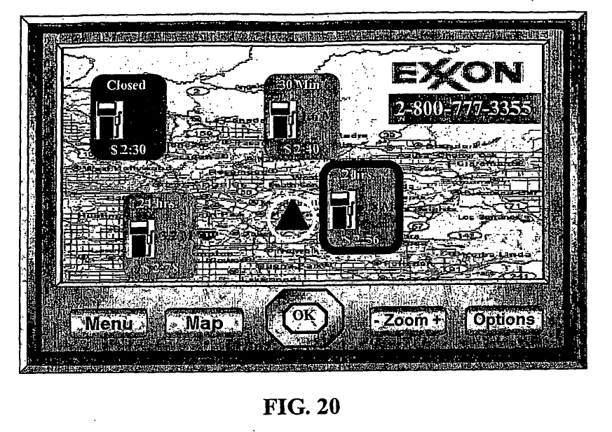

FIG. 20 illustrates one example of one implementation of how associated data to an identifier may be displayed to a user in connection with the operation of a navigation system. In this case, the associated data is a group address. It should be noted again that this data might be available locally or downloaded from a server in real-time after the user inputs the identifier and presses “Enter”. Closing time, distance and price of gas are tagged to each icon. The same information may be presented differently when displayed by another device such as a cell phone with a different type of display. This information may be added to the contact manager by pressing “Add to Contact” button. This is an example of how data is assembled, processed and presented based on the current date, time and user preferences, e.g., price is for regular gas which is selected by the user.

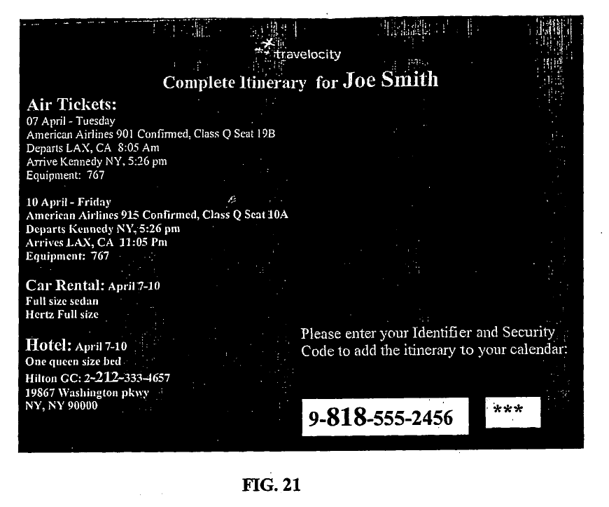

FIG. 21 is an example of a screen display of a travel itinerary that may be viewed by accessing a website using a web browser. As illustrated, the travel itinerary includes an option for entering an identifier with security code. By entering an identifier and security code, a user can add the travel itinerary to the user's calendar. In this example, it is illustrated that an identifier may be used to transmit travel information to a user's account, associate the travel data with an identifier and allow the user to automatically store the travel information in a contact/scheduling management system 134, which may include all the addresses in the itinerary that may be used for navigation.

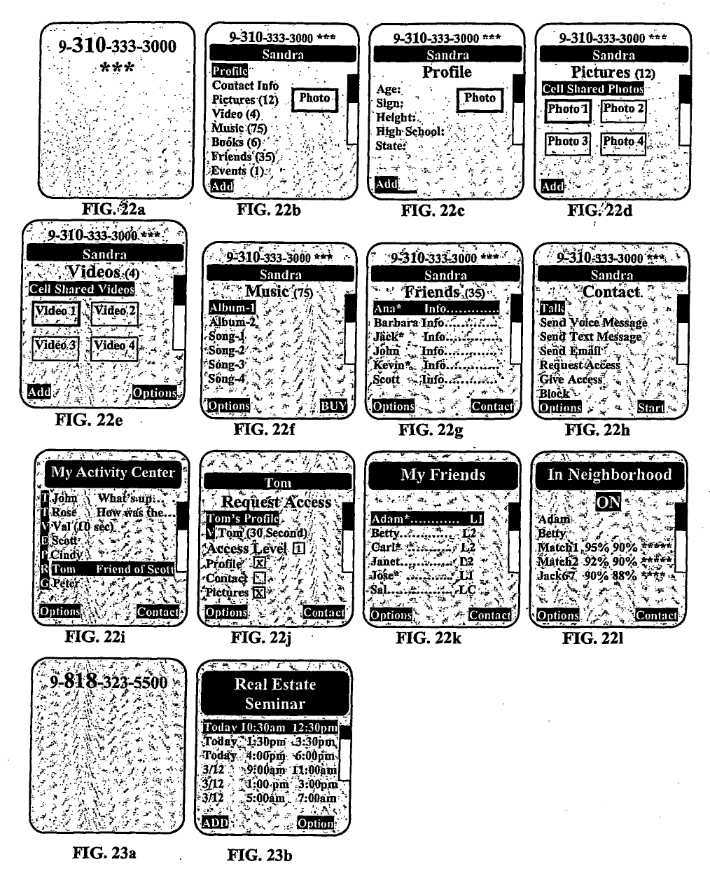

FIG. 22a illustrates an example of one input screen that may be displayed on a cell phone to interface with an ISS 100. In this example, an identifier “0-310-333-3000” is input into the screen along with a 3-digit security code represented by “***”. As illustrated in FIGS. 22b-22k, the identifier with security code may provide access to a variety of different types of information associated with the registered owner of the identifier. As will be demonstrated further below, the security code used with the identifier may determine the level of access to the data associated with the identifier.

FIG. 22b illustrates an example of one screen display that may be retrieved when the identifier and security code illustrated in FIG. 22a is entered into a cell phone. In this instance, the identifier is associated with data provided by Sandra. In this example, the screen display can serve as a home page for a personal account for Sandra. User's accessing Sandra's displayed information may select from a variety of activities and information available to a user. Depending upon the level of security associated with the use of a particular security code or associated with access given to a particular user, certain information and activities may not be available to all users accessing Sandra's personal data. In this case, a profile for Sandra may accessed, along with picture(s), video(s), music, book(s), friend(s), event(s) and other information that Sandra has made available for access using the security code. Users with different security codes having differing access levels may have access to different, more restricted or additional information. The number in parenthesis shows the number of each item in each section. In this example, access to contact information, such as telephone number, address etc. is not provided as the security code entered does not authorize access to such information. Select information may be added to the contact manger by selecting “Add” or by pressing S1 on the user's cell phone. Alternatively, Sandra may be contacted by selecting “Contact” or by pressing S2 on the user's cell phone.

FIG. 22c illustrates one example of a screen display that may be utilized to show a profile. In this example, if “Profile” is selected from the list of options in FIG. 22b, the profile information associated with the identifier may then be displayed, as illustrated in FIG. 22c. In this example, personal information, such as age, sign, height, educational information and location information may be included in a profile. A profile may also include other information that an individual would like to share, as well as a photo. The person or entity accessing the information may then save the profile information by selecting “Add” or by pressing S1 on the user's cell phone, as illustrated in FIG. 9. Alternatively, Sandra may be contacted by selecting “Contact” or by pressing S2 on the user's cell phone, as illustrated in FIG. 9.

FIG. 22d illustrates one example of a screen display that may be utilized to show shared photos associated with an identifier. In this example, if “Pictures” (or photos) is selected from the list of options in FIG. 22b, the pictures associated with the identifier may then be displayed, as illustrated in FIG. 22d. In this example, cell phone shared photos are the photos Sandra has made available to share with others. The person or entity accessing the information may then save specific photos by selecting the photo and then selecting “Add” or pressing S1 on the user's cell phone. Alternatively, other activities may be performed utilizing the images. Such other options may be viewed by selecting “Options” or by pressing S2 on the user's cell phone.

FIG. 22e illustrates one example of a screen display that may be utilized to show shared videos associated with an identifier. In this example, if “Videos” is selected from the list of options in FIG. 22b, the videos associated with the identifier may then be displayed, as illustrated in FIG. 22e. In this example, cell phone shared videos are the videos Sandra has made available to share with others. The person or entity accessing the information may then save specific videos by selecting the video to be saved and then selecting “Add” or pressing S1 on the user's cell phone. Alternatively, other activities may be performed utilizing the videos. Such other options may be viewed by selecting “Options” or by pressing S2 on the user's cell phone.

FIG. 22f illustrates one example of a screen display that may be utilized to show shared music associated with an identifier. In this example, if “Music” is selected from the list of options in FIG. 22b, albums or songs associated with the identifier may then be displayed, as illustrated in FIG. 22f. In this example, various albums and songs Sandra has selected to make available to share with others are displayed. The person or entity accessing the information may then perform various tasks, such as viewing song or album information, or playing all or a portion of the song by selecting “Options” or pressing S1 on the user's cell phone. Alternatively, the user may be given the option to buy all or a portion of the music information made available by Sandra by selecting “Buy” or by pressing S2 on the user's cell phone.

FIG. 22g illustrates one example of a screen display that may be utilized to show information regarding friends of the owner of the identifier. In this example, if “Friends” is selected from the list of options in FIG. 22b, a listing of Sandra's friends may then be displayed, as illustrated in FIG. 22g. The friends with a may indicate those friends of Sandra that Sandra knows in the physical world or have been added to her list by inputting an identifier for that individual. From this screen, Sandra's friends may be contacted by highlighting the desired friend and selecting “Contact” or pressing S2 on the user's cell phone. Alternatively, other activities may be performed utilizing the friend list, such as viewing additional information pertaining to a particular friend, such as a friend's profile. Such other options may be viewed by selecting “Options” or by pressing S1 on the user's cell phone.

FIG. 22h illustrates one example of a screen display that shows different mechanisms by which an individual may be contacted by selecting the “Contact” option. In this example, when Contact is selected from the screen, as illustrated in FIG. 22b, 22e or 22g, for example, the user may be provided with a number of options regarding the manner in which the user would like to initiate contact. For example, the user may be given the ability to select from all or a portion of the following options, among others: Talk, Send Voice Message, Send Text Message, Send Email, Request Access, Give Access, and Block. Depending upon the level of security granted by the security code, not all of these options may be available to a particular user and may appear grayed out. For example, the Contact info in FIG. 22a is grayed out because the security code entered in association with the identifier does not give the user the authority to access that information. Other security code(s) having less restrictive access requirements may give the user the ability to access Contact Info.

If the “Talk” option is selected, it may give the user the ability to call someone else without utilizing or even possessing their telephone phone number. When the request is received to call someone, the ISS 100 may check for access privileges of the requester and dial the number. In this regard, the ISS 100 may allow for certain individuals and entities to be blocked from contacting an individual without requiring a person to change their telephone number.

When “Talk” is pressed, the connection to the contact may be established in a number of different ways. For example, the phone number of the target member that is retrieved and dialed may be the contact's mobile phone number. Actions may be taken to make sure that no trace of the number is left in the user's phone; e.g., in the outgoing calls record, etc. The caller ID may also be turned off to make the contact's number unavailable to the other party.

Voice over IP (“VoIP”) technology may also be used to contact another party using the talk option. In this example, the user's voice is turned into a digital signal and is forwarded through the Internet to the other party. Other party's IP address is registered to the ISS 100 permanently or dynamically as the member's logs in. The other party may receive the call directly through another VoIP capable device, e.g., computer or another cell phone, or via an intermediary device that turns VoIP into a regular phone call. On the return path, the digital signal is turned into voice. Similarly, a third party VoIP service such as Skype® or Google® phone may be used to contact a third party. Skype® is a registered trademark of Skype® Technologies, S.A. and Google® is a registered trademark of Google, Inc. A member may add their Skype® and/or Google® phone ID into their profile. This information is used to make a connection between two people but is not given out unless approved by the owner. When “Talk” is selected, the member's voice is translated into a digital signal and sent to the server where it is forwarded to the other party's corresponding Skype®, Google® or other VoIP account. In this example, the server will be acting as a switchboard directing the IP traffic. A VoIP service, such as Skype® or Google® phone, may be used as the backbone for a VoIP network that may be used in connection with the ISS 100. In this instance, users of the ISS 100 are not required to have Skype®, Google® phone accounts or other independent VoIP accounts. Rather, a VoIP network service, such as Skype® or Google® phone, is used to establish an IP connection between users of the ISS 100. When the users of the ISS register, the registration includes their IP addresses. When the “Talk” button is pressed, the system knows the IP address of the call originator as well as the intended receiver. A connection is established between the originator and receiver using a commercial network. In one example of one implementation, similar techniques, e.g., direct dialing, VoIP, etc., may be used to leave a voice message for other members. Using a VoIP service as a backbone further allows for multiple people to easily communicate with one another on the same call.

If “Send Voice Message” is selected, a voice message may be recorded and sent. Again, a voice message may be recorded and sent by an individual without the individual utilizing or even possessing the other party's telephone number. Similarly, if “Send Text Message” is selected, a text message may be composed and sent; again, without the need for the contact telephone number. In the same manner as a text message, if “Send Email” is selected, an email may be composed and sent without having the actual email address of the individual.

If “Request Access” is selected, the ISS 100 may send a request to a particular contact to get access to secure information. If “Give Access” is selected, the ISS 100 may grant the owner of the identifier of the account being viewed access to the user's secure information. If “Block” is selected, the owner of the identifier will be blocked from contacting the user and gaining access to information.

Although not illustrated, “contact” could be associated with a group of people rather than an individual. In this case, the user may be able to talk to all or a portion of the members of the group, send messages, such as voice, text and email, to all or a portion of the members of the group, exchange access rights and etc.

FIGS. 22i, 22j, 22k and 22l illustrate several different examples of screen displays that may be utilized to assist an individual with managing their personal account. Although the screen displays illustrated in FIGS. 22a-22h may be accessed and viewed by anyone having a correct security code, the information displayed on the screens illustrated in FIGS. 22i, 22j, 22k and 221 will likely only be accessible by the owner of the identifier. Access to such information may be granted by utilizing a security code assigned for use only by the account holder.

FIG. 22i illustrates one example of a screen display showing an activities center that may provide access to a combination of personal information and allow the user to perform a number of activities. In this example, “My Activity Center” may allow the user to access his inbox, outbox and perform a number of other activities. In the inbox, a number of different types of messages are displayed. The message type may be indicated by the following prefix: T (Text), V (Voice Message), E (Event), P (Picture), R (Requesting Access), G (Granting Access). As illustrated, in Sandra's activity center, it can be seen that she has received a text message from John and Rose, a voice message from Val, and an event notification from Scott (which may be easily added to Sandra's contact database), a picture from Cindy, a request from Tom to be given access to her profile and notification that Peter has given Sandra additional access to his account information. From here, Sandra can respond to any of these messages with any type of message. For example, Sandra may receive a text message and respond to it with a voice message.

FIG. 22j illustrates one example of a screen display that demonstrates the granting of user access to information associated with an identifier. In this example, Tom has requested access to Sandra's personal information. This request was sent to Sandra and can be seen in FIG. 22i. FIG. 22j illustrates one example of a screen display that may appear if “R-Tom Friend of Scott” is selected from the list in FIG. 22i. Here Tom's profile, as well as a thirty (30) second voice message from Tom, is available for review. Sandra can then give Tom a predefined access level (L1, L2, L3, . . . ) or customize access by checking appropriate boxes for different data. In addition, for example, Sandra may give Tom the ability to send her text messages but not voice messages, email or etc, but selecting the activities that she would like to give Tom the ability to perform. Such specific access is illustrated in FIG. 22j by selecting the box that coincides with the activity.

FIG. 22k illustrates a display screen that allows an owner of an identifier to view a list of all the people and, entities to which they have given access to data. Such listing includes the access level granted to each person or entity in the list. In this example, the screen display is titled “My Friends” and lists Sandra's friends and their various access levels. From this screen, Sandra may contact friends on her list by highlighting the desired friend and selecting “Contact” or pressing S2 on the user's cell phone, as illustrated in FIG. 9. By selecting “Options” or pressing S1 on the user's cell phone, Sandra may be given the ability to perform other activities associated with those names listed on her “My Friends” list. For example, Sandra may be given the option of changing friend access levels, in addition to performing other tasks.

Access rights may be saved under the data user account or the data owner account. If saved under the data owner account, all the people who have access to the account as well as their access right level is kept by the ISS 100 in association with the data owner's account. Further, if saved under the data user's account, the security code to access the information may be saved by the ISS 100, at the data user account. There could be a hybrid system where both methods are used simultaneously in a complementary or redundant manner, e.g., a code with a security code is kept at the data owner accounts, while some other accounts that were not originally started with access to a security code may be managed by the data owner.

FIG. 22l illustrates one example of a screen display that allows the owner of an identifier to view information about other registered users that meet specified criteria. When a user is completing his or her profile, the user may have the option to complete additional information that may assist the system with matching individual profiles with one another that meet specified criteria. For example, in additional to giving general information about oneself, the user may have the option to provide details regarding the user's particular likes and dislikes (such as cats, dogs, outdoors, food), hobbies (skateboarding, fine dining, travel) and even qualities and or characteristic he or she is looking for in a companion, boyfriend, girlfriend, spouse, etc. This information may be gathered using different means including dropdown menu, radio buttons, checkboxes, typing it in etc. While this information may be completed as part of an individual's profile, this information may also be gathered through another input screen designed specifically for the purposes of matching profiles based upon defined criteria.

As part of completing a compatibility profile, the individual may also be given the option to designate specific traits that they are looking for in another. For example, a high school student that just moved to a new area may be looking for other students his or her age that like to play basketball, baseball or other activities. Physical traits could also be specified, such as gender and height to name of a few. The search criteria could be exact, e.g., male/female, a range, e.g., age 25-30, multiple options, e.g., basketball or football, among other criteria.

In this example, when a user is actively looking for friends, they may turn on the “In Neighborhood” option. When this option is on, other individuals that meet certain designated criteria may appear on users “In Neighborhood” list. In this example, all the individuals that are located with a certain radius of the user and that meet certain criteria may appear on the list. The radius in which the searching should be performed may be established by the user. Additionally, friends of the user that are on-line and are located within a certain radius may be displayed.

Manually searching can also be performed based on certain select criteria. Further, other people that match the member criteria and/or the member matches their criteria will popup on the screen. In this example, Match-1 fits 95% of the user's criteria, while the user fits 90% of that person's criteria. Each person may also have an average star rating from other friends displayed in front of their names. When members interact with each other they may give each other star ratings. These star ratings may be tabulated and averaged. Details of the rating as well as any comments may also be available.

Further, minimum match percentages, to be displayed on the In Neighborhood, may be programmable by the user. For example, a user may set the criteria for inclusion of a match in the “In Neighborhood” list as anyone that meets 90% of her criteria and she meets 85% of the other person criteria. Further, a user may also have the capability to add criteria for popping up on someone else's “In Neighborhood” screen. For example, a user may request that she would pop up on someone else's screen only if that person fits 90% of her criteria and/or she fits 85% of the other person criteria and they have minimum of 4 stars feedback. In this example, Match1 and Match2 choose not to have their profile visible while Jack67 has his available for view.

When “In Neighborhood” is activated, the current position of the each member is forwarded to the ISS 100 where periodically, other members within a certain distance that fit the criteria are identified and displayed. Identifying a member's match may take place offline, e.g., a list of all members that fit a user criteria are identified and saved. This will reduce the real-time processing requirement. In this example, ISS 100 only needs to find out if anyone in the list is within a certain radius from the user and provide information regarding those individuals to the user. The user may also have access to this list and able to contact those listed in the “In Neighborhood” screen if desired, even if not in their proximity.

In a similar manner, career information and preferences may be made part of a users profile or may be input through an alternative screen input. The user may then be able to view job posting that match their criteria. Companies or individuals seeking to hire may also be able to perform similar searches and display users that meet the company or individuals defined criteria.

While all of the above examples illustrate the manual entry of an identifier on a cell phone, website or navigation system, an identifier or a bar code may be automatically obtained by a system using different methods. Such automatic methods may include, but not be limited to, barcode readers, radio frequency identification (“RFID”) readers, card readers, cameras (including cell phone cameras) and etc. For example, a barcode may be included on a business card that is associated with an identifier. This barcode may be read by a barcode reader and transformed to a number that is representative of an identifier. A camera, e.g., camera on a mobile phone may be used as a front-end for capturing bar codes and identifiers.

In another example of one implementation, a camera, e.g., camera on a mobile phone, may take a picture of the business card. The picture of the business card may be run through an Optical Character Recognition (“OCR”) and an Identifier Recognition Module (IRM) to look for a corresponding identifier. This corresponding identifier may be used in place of manual entry. An IRM is a module that recognizes a series of characters that potentially could be an identifier, isolates it from other characters that might be present. Further, IRM may also pass the recognized identifier to other programs or may simulate a manual entry into another program among other functions. In one example, the OCR/IRM may be running locally, e.g., in a computer connected to a card reader, a cell phone or a PDA with an integrated camera. In this example, the camera and the scanner are virtually doing the same thing, which is grabbing the picture of the card. Alternatively, in another example of another implementation, the OCR/IRM may be running off-board on a remote server such as ISS 100. In this case, the photo will be sent to the server.

In one example of one implementation although not necessary, to simplify identification of an identifier and increase accuracy, a certain font may be recommended to be used to display identifiers and/or a certain characters such as “GC” may be added in a location proximate to the identifier, e.g., GC 9-310-888-8888. By using a certain font or having certain characters near the identifier or other distinguishing factors such as color etc., the program that looks for the identifier (e.g. IRM) may be assisted with locating and reading the identifier. The number of characters in an identifier, the grouping of the identifier and other characteristics may also be used to identify and distinguish the code from other types of information. The program that looks for the identifier (e.g. IRM) may be integrated into the OCR or run separately after the characters on the picture are identified. In this example, IRM may go through the string of characters identified by the OCR looking for numbers in a certain font, numbers that are grouped in a specific way, or numbers that are preceded by “GC”, for example. In one example of one implementation, when the program used to identify the characters that are representative of the identifier (e.g. IRM) is integrated with the OCR, they may work cooperatively so that OCR would not be required to try to recognize the characters that do not fit the criteria (e.g. other characters in the picture that do not represent an identifier). This may increase the overall efficiency of the identification process.

In one example of one implementation, when a series of characters are identified that appear to represent an identifier, the identifier may be checked against a database to determine if the identifier is a valid identifier before retrieving associated data or presenting the identifier to the user for review. It may be desirable, in certain instances, to present the identifier to the user for verification.

There are many other ways of automatically inputting an identifier or a code methods for which are known at this time or will be available in the future. It is intended that all such additional methods be included within this description, be within the scope of the invention, and be protected by the accompanying claims.

In one example of one implementation, the system may be setup such that every photo taken is automatically ran through the OCR/IRM and if a valid identifier is found, it will be processed as if the user had entered it manually. The level of automation and assumptions may be set by the user through options.

In another example of one implementation, a poster for an event, e.g. a concert, sports game or movie, may have a corresponding identifier. This identifier may be printed on the poster, a sticker on the poster, or posted in the vicinity of the poster using a separate label. A user can then enter the identifier into his or her cell phone manually using a keypad or using the mobile camera to capture a picture of the poster that can then be run through an OCR/IRM and once the identifier is located, it may be automatically entered into the user's cell phone.

Although not described in detail above, those skilled in the art will recognize a number of various applications and various functionalities that would fall within the scope of the invention. For example, the identifier could be linked to highly personal information, such as medical records. In this case, the identifier could be given to a doctor with a secured password to all the doctor or health care provider to access information. In one example of one implementation, the doctor's office may have a keypad that is connected to their computer system allowing patients to privately input their identifier to give the doctor access to the medical information and to, for example, complete a patient history file. Further, identifiers could be used to retrieve personal information to complete all or part of the form document or standardized field of certain form documents. Information can be retrieved or input in one language and made available in a variety of different languages. In one implementation, a user may have the option of setting up a preferred language. Regardless of how the information was input, the information would be retrieved in the preferred language. In summary, an identifier can be associated with a variety of type of information that can be used for the purpose of exchanging data, obtaining data, providing data to another or to process a transaction, such as a commercial transaction.

In addition to using identifiers in contact management applications, word processing applications and navigation application, the ISS 100 identifiers may be used to retrieve any type of information or data in an electronic format for subsequent use by a user or a user application that would generally need to be manually input into an application for use. Contact identifiers may be provided on business cards, provided in look-up databases and used and disseminated in a manner similar to the dissemination of addresses and telephone numbers. Further, the overall functionality of the above described methods and systems may be performed through the use of more than one system or software program capable of interfacing with one another. Bach of these various systems or software programs may be considered a separate component or module of a larger system. For example, one component may provide for the receipt of an identifier and may process the identifier or associate the identifier with data requested by or required by another component of the system. The data collection module 102 may be programmed to automatically gather data from different sources, such as other databases (“DBs”) or third party systems 126 and associate the additional data with an identifier. In one example, this may include all photos and other background information available about a person and add the data to the main database module 104 under the associated identifier.

FIG. 23a illustrates an example of one input screen that may be displayed on a cell phone to interface with an ISS 100. FIG. 23b illustrates an example of one screen display that may be retrieved when the identifier illustrated in FIG. 23a is entered into a cell phone. In this instance, the identifier is associated with a Real Estate Seminar with multi-session event data. In this example, the current date and time is used to list the upcoming sessions. By pressing “S1” the highlighted session may be added to the calendar and/or the contact manager. This may include information about the location, description, prerequisites, contact information etc. By pressing “S2” the user may be given additional options such as choosing different data and time, location, etc.

An identifier system may be organized in many different ways. Described below are a few examples, taken from many possible implementations, that may be used to construct an identifier system. While the examples below construct the identifiers from a series of numbers, it is not necessary that the identifier consist only of numbers. Any types of character may be used to construct an identifier, including letters and symbols. For example, a company may have an identifier of 2-800-555-1234. When this identifier is used, the user may obtain general information about the company. Each employee of the company may have an identifier that starts with the same identifier as the company and continues with different extensions for different employees, for example, 2-800-555-1234-001 may be used for one employee and 2-800-555-1234-002 for another employee. These identifiers may give access to information about individual employees, perhaps in addition to the company information. In one example of an implementation, as a matter of standard, a particular suffix may be used to provide different information about a single entity. For example a “1” suffix may give business information, a 2 suffix may give personal information and 3 suffix may direct the user to a personal website, e.g., 9-818-827-2988-1, 9-818-827-2988-2, 9-818-827-2988-3. Alternatively, different prefixes may be utilized to distinguish types of identifiers, such as company, individual, products, events, public information, contact information, personal information, etc.

Persons skilled in the art will understand and appreciate, that one or more processes, sub-processes, or process steps described in connection with FIGS. 1 through 23 may be performed by hardware and/or software. Additionally, an ISS 100 system may be implemented completely in software that would be executed within a processor or plurality of processor in a networked environment. Examples of a processor include but are not limited to microprocessor, general purpose processor, combination of processors, DSP, any logic or decision processing unit regardless of method of operation, instructions execution/system/apparatus/device and/or ASIC. If the process is performed by software, the software may reside in software memory (not shown) in the device used to execute the software. The software in software memory may include an ordered listing of executable instructions for implementing logical functions (i.e., “logic” that may be implemented either in digital form such as digital circuitry or source code or optical circuitry or chemical or biochemical in analog form such as analog circuitry or an analog source such an analog electrical, sound or video signal), and may selectively be embodied in any signal-bearing (such as a machine-readable and/or computer-readable) medium for use by or in connection with an instruction execution system, apparatus, or device, such as a computer-based system, processor-containing system, or other system that may selectively fetch the instructions from the instruction execution system, apparatus, or device and execute the instructions. In the context of this document, a “machine-readable medium,” “computer-readable medium,” and/or “signal-bearing medium” (herein known as a “signal-bearing medium”) is any means that may contain, store, communicate, propagate, or transport the program for use by or in connection with the instruction execution system, apparatus, or device. The signal-bearing medium may selectively be, for example but not limited to, an electronic, magnetic, optical, electromagnetic, infrared, or semiconductor system, apparatus, device, air, water, or propagation medium. More specific examples, but nonetheless a non-exhaustive list, of computer-readable media would include the following: an electrical connection (electronic) having one or more wires; a portable computer diskette (magnetic); a RAM (electronic); a read-only memory “ROM” (electronic); an erasable programmable read-only memory (EPROM or Flash memory) (electronic); an optical fiber (optical); and a portable compact disc read-only memory “CDROM” “DVD” (optical). Note that the computer-readable medium may even be paper or another suitable medium upon which the program is printed, as the program can be electronically captured, via, for instance, optical scanning of the paper or other medium, then compiled, interpreted or otherwise processed in a suitable manner if necessary, and then stored in a computer memory. Additionally, it is appreciated by those skilled in the art that a signal-bearing medium may include carrier wave signals on propagated signals in telecommunication and/or network distributed systems. These propagated signals may be computer (i.e., machine) data signals embodied in the carrier wave signal. The computer/machine data signals may include data or software that is transported or interacts with the carrier wave signal.

It will be apparent to those of ordinary skill in the art that many more implementations are possible within the scope of this invention than those set forth above. Accordingly, the invention is not to be restricted by the described implementations. Further, the invention is not to be restricted to the described implementations and uses of an ISS 100, whether implemented in hardware, software or any combination thereof, but is intended to encompass any ISS 100 that is capable of receiving, recognizing, handling, or processing a data in association with a data identifier, whether implemented in hardware, software or a combination thereof.

1. A method for associating data with an identifier that allows a third party system to retrieve and process the associated data using the identifier, the method comprising collecting data from a source and associating an identifier with the data, storing the data in a database, retrieving the data associated with the identifier in response to a request from a third party system and providing the data to such third party system in a format that can be utilized by such third party system.

2. The method of claim 1 where the identifier further includes a security code that prevents a third party system from obtaining certain data associated with the identifier absent accompanying the identifier with the security code.

3. The method of claim 1 where the data associated with the identifier is contact data.

4. An information sharing system comprising.
a database;
a data collection module that collects data from different sources, associates collected data with data identifiers and stores the collected data and its associated data identifiers in the database; and
a data dissemination module that receives a data identifier from a requester, retrieves collected data associated with the data identifier and provides the collected data associated with the received data identifier to the requester in a format that will allow the requester to process the collected data.

5. The system of claim 4 where the collected data is contact data.

6. The system of claim 4 where the collected data is event data.

7. The system of claim 4 where the collected data is metadata.

8. The system of claim 4 where the requester is a user application.

9. The system of claim 4 where the requester is a person.

10. The system of claim 4 where the requester is a contact management application.

11. The system of claim 4 where the identifier is randomly generated.

12. The system of claim 4 where the identifier is assigned by the data collection module.

13. The system of claim 4 where the identifier is assigned by the data source.
